(19) United States
(12) Patent Application Publication
(10) Pub. No.: US 2026/0236702 A1
(43) Pub. Date: Aug. 13, 2026

(54) Three-Sector Curvature Exchange Architecture with Conservation-Governed Cognitive Dynamics

(71) Applicant: AtomBeam Technologies Inc., Moraga, CA (US)

(72) Inventor: Brian Galvin, Silverdale, WA (US)

(21) Appl. No.: 19/574,285

(22) Filed: Mar. 21, 2026

Related U.S. Application Data
(63) Continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/321,168, filed on Sep. 5, 2025, now Pat. No. 12,585,882.
Application No. 19/321,168 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for cognitive processing maintain a geometric representation of knowledge divided into three regions: an active region where reasoning occurs, an irreversible region storing consolidated knowledge, and a boundary region mediating exchange between them. A conservation law governs how representational complexity flows among these regions, ensuring that complexity is redistributed rather than created or destroyed during processing. Four exchange pathways regulate this flow: consolidation transfers knowledge from active to irreversible storage, restructuring reorganizes knowledge within the active region, boundary accumulation strengthens the protective barrier around consolidated knowledge, and reflux returns consolidated knowledge to active processing when revision is warranted. Revising consolidated knowledge requires substantially more energy than consolidating it, providing stability against casual perturbation. The system detects unreliable reasoning conditions as specific violations of these exchange dynamics, identifying four distinct failure modes including barrier penetration, concealment of evidential inconsistency, premature consolidation, and exchange channel stagnation.

### CROSS-REFERENCE TO RELATED APPLICATIONS

Priority is claimed in the application data sheet to the following patents or patent applications, each of which is expressly incorporated herein by reference in its entirety:
Ser. No. 19/550,709
Ser. No. 19/548,024
Ser. No. 19/546,407
Ser. No. 19/534,677
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
Ser. No. 19/321,168
Ser. No. 19/284,115
Ser. No. 19/051,193

### BACKGROUND OF THE INVENTION

### Field of the Art

The present invention relates to the field of artificial intelligence and cognitive computing systems, and more specifically to conservation-governed cognitive architectures in which reasoning, learning, and knowledge consolidation occur within a geometrically structured manifold governed by curvature exchange dynamics.

### Discussion of the State of the Art

Contemporary artificial intelligence and cognitive computing systems increasingly rely on large-scale machine learning models and complex data processing pipelines to perform reasoning, pattern recognition, and decision support tasks. Many modern systems employ neural network architectures, such as transformer-based large language models, in which reasoning and inference are represented as transformations within high-dimensional latent spaces. These architectures have demonstrated substantial capabilities across diverse applications including natural language processing, scientific analysis, and decision support. Despite these advances, the internal operation of many such systems remains governed primarily by statistical association rather than by explicit structural principles that regulate how knowledge evolves, stabilizes, or interacts with prior learning.

In many currently deployed architectures, knowledge acquisition and reasoning occur without a unified governing framework describing how representational complexity is introduced, redistributed, consolidated, or revised over time. Neural network inference, for example, commonly generates intermediate activations that are consumed during computation and discarded afterward, without maintaining an explicit accounting of how representational structure propagates through successive stages of reasoning. Similarly, systems that incorporate persistent storage mechanisms, such as vector databases, retrieval augmentation frameworks, or memory caches, typically store information additively without a principled mechanism that determines when knowledge should become durable, when it should remain provisional, or when it should be reconsidered in light of contradictory evidence.

Various approaches have been developed to address the challenges of knowledge management and reasoning reliability. Retrieval-augmented systems combine generative models with external knowledge stores in an attempt to ground outputs in stored information. Memory-augmented neural networks provide explicit memory components that can be read and written during computation. Multi-agent architectures distribute reasoning tasks across cooperating agents that specialize in different domains or reasoning roles. Although these approaches may improve performance in specific scenarios, they generally treat memory formation, reasoning traversal, and revision as independent mechanisms rather than as manifestations of a unified structural process. As a result, coordination overhead may increase as systems scale, and the relationship between stored knowledge and active reasoning often remains heuristic rather than principled.

Another challenge in existing artificial intelligence systems is the phenomenon commonly referred to as hallucination, in which generated outputs may contain statements that appear coherent or plausible but lack adequate evidential grounding. Current approaches typically address hallucination through mechanisms such as confidence estimation, post-generation filtering, external verification, reinforcement learning from human feedback, or retrieval-based grounding. While these mechanisms may reduce the occurrence of incorrect outputs in certain contexts, they generally operate after reasoning has already occurred. In such cases, the system may attempt to identify or correct problematic results without a structural mechanism that prevents the formation of inadmissible reasoning trajectories in the first place.

Existing architectures also often lack a framework that unifies learning, consolidation of knowledge, revision of prior conclusions, and detection of reasoning anomalies within a single governing principle. In many systems, the processes responsible for incorporating new information, maintaining previously learned knowledge, and revising existing structures operate independently. Consequently, systems may encounter tradeoffs between stability and adaptability. For example, methods designed to preserve existing knowledge may limit the system's ability to incorporate new information, while methods designed to support continuous learning may inadvertently alter or degrade previously acquired knowledge.

Further, although many systems maintain internal representations of knowledge in latent vector spaces or other structured representations, such representations typically encode semantic similarity rather than explicitly representing structural relationships governing how knowledge is stabilized or how inconsistencies are resolved. Without such structure, it can be difficult to determine whether a reasoning trajectory reflects a well-supported inference or whether it represents a path that should be revised or reconsidered. In addition, the absence of a principled mechanism for regulating how knowledge transitions from provisional reasoning states to durable storage can lead to inefficiencies in both reasoning performance and long-term knowledge organization.

Accordingly, improvements in cognitive computing architectures may benefit from a unified structural framework capable of coordinating reasoning traversal, knowledge consolidation, revision dynamics, and reliability monitoring. A framework that represents knowledge within a persistent geometric substrate and regulates how information flows through that substrate according to well-defined structural principles may provide a basis for improving reliability, interpretability, and scalability of cognitive computing systems.

What is needed is a computer system and method for cognitive processing in which reasoning, learning, consolidation, and revision occur within a persistent geometric representation governed by structural constraints that regulate how representational complexity flows through the system, and in which detection of unreliable reasoning trajectories is integrated with those structural dynamics so that knowledge consolidation, revision, and reasoning reliability can be managed within a unified computational architecture.

### SUMMARY OF THE INVENTION

Accordingly, the inventor has conceived and reduced to practice a computer system and corresponding methods for conservation-governed cognitive processing in which cognition occurs within a three-sector cognitive architecture formed on a cognitive manifold and governed by a curvature conservation law. In such a system, an active sector supports dynamic reasoning traversal, an irreversible sector stores consolidated knowledge reservoirs having low internal epistemic curvature and high barrier energy, and a boundary sector mediates exchange between active reasoning and consolidated knowledge. Curvature is redistributed among sectors through a plurality of exchange channels including consolidation, restructuring, boundary accumulation, and reflux, with consolidation energetically favored over reflux according to barrier-energy-dependent asymmetry. Hallucination conditions are detected not merely as incorrect outputs, but as curvature misrouting events including channel bypass, curvature laundering, premature export, and blocked export. Through this arrangement, a computer system may, for example, maintain persistent geometric knowledge structures, verify conservation of curvature energy across sectors, detect exchange failures using sector-sensitive geometric diagnostics, and improve reliability of cognitive processing by coupling learning, revision, and hallucination detection to a common conservation-governed exchange framework.

In an embodiment, a computer system comprises at least one processor, a memory, and programming instructions that cause a computing system to maintain a three-sector cognitive architecture including an active sector in which reasoning occurs as dynamic traversal of a cognitive manifold, an irreversible sector including consolidated knowledge reservoirs whose connection structure has epistemic curvature below a flatness threshold and barrier energy exceeding a barrier threshold, and a boundary sector that mediates exchange between active and irreversible sectors, while enforcing a curvature conservation law by verifying, for example on a per-cycle basis, that total curvature change across all three sectors equals curvature injected by a projection operator within a numerical tolerance, implementing exchange channels that govern curvature flow among sectors including consolidation, restructuring, boundary accumulation, and reflux, with energetic cost of reflux exceeding energetic cost of consolidation by a factor determined by accumulated barrier energy at a reservoir boundary, and detecting hallucination conditions as curvature misrouting events including, for example, channel bypass, curvature laundering, premature export, and blocked export.

In an aspect of an embodiment, a cognitive manifold is an epistemically conditioned manifold equipped with mutually compatible geometric structures including a Riemannian semantic metric, an almost-complex structure, a compatible symplectic form satisfying an almost-Kähler compatibility condition, and an epistemic line bundle with a connection whose curvature measures evidential coherence.

In an aspect of an embodiment, each consolidated knowledge reservoir in an irreversible sector satisfies conditions including phase flatness such that a supremum of epistemic curvature within a reservoir is bounded by a flatness threshold determined by evidence consistency and a spectral gap of a connection Laplacian, barrier energy at a reservoir boundary at least equal to a barrier threshold determined by a curvature budget of a curvature conservation law, and admission control at a reservoir boundary that routes compatible cognitive states into a reservoir while excluding incompatible cognitive states.

In an aspect of an embodiment, a consolidation channel operates in stages including epistemic relaxation in an active sector, curvature migration through boundary edges, barrier accumulation at reservoir boundaries, and exchange equilibrium, where such stages may emerge from continuous relaxation dynamics under a curvature conservation law.

In an aspect of an embodiment, a reflux channel is driven by holonomy mismatch such that contradictory evidence accumulates curvature at a boundary sector that is incompatible with consolidated content of a corresponding reservoir, and reflux activates when accumulated mismatch exceeds a threshold determined by barrier energy of that reservoir.

In an aspect of an embodiment, exchange channels are ordered by timescale such that a restructuring channel operates at a fast timescale, a consolidation channel and a boundary accumulation channel operate at an intermediate timescale, and a reflux channel operates at a slow timescale, with such timescale ordering reflecting thermodynamic asymmetry such that energetic cost of activating reflux exceeds energetic cost of activating consolidation by a factor determined by accumulated barrier energy at a reservoir boundary.

In an aspect of an embodiment, detecting channel bypass comprises maintaining a barrier-edge bitmap that tracks edges of a simplicial complex crossing sector boundaries and monitoring whether curvature transport crosses barrier edges without corresponding exchange accounting consistent with a curvature conservation law.

In an aspect of an embodiment, detecting curvature laundering comprises continuously monitoring epistemic holonomy accumulated along active reasoning trajectories and flagging a trajectory when epistemic phase drift exceeds a threshold, with monitoring occurring, for example, at a rate of at least one evaluation per characteristic laundering timescale so that detection occurs before laundering is complete.

In an aspect of an embodiment, detecting premature export comprises monitoring a symplectic capacity density at reservoir boundaries and preventing curvature export when post-insertion capacity density exceeds a threshold derived from a symplectic non-squeezing constraint on consolidated knowledge volume.

In an aspect of an embodiment, detecting blocked export comprises monitoring per-sector curvature flow rates and per-reservoir exchange balance and identifying exchange-stagnated regions where all exchange channels from a region are simultaneously saturated, as indicated, for example, by unchanging curvature despite evidence flux, maximal coupling strain, and boundary capacity exhaustion.

In an aspect of an embodiment, a computer system is further configured to detect epistemic horizons as connected regions of an active sector where all exchange channels are simultaneously saturated, curvature is trapped, coupling strain is maximal, and dynamics have stalled.

In an aspect of an embodiment, a cognitive manifold is realized as a simplicial complex stored on GPU hardware with a persistent CUDA graph, and exchange dynamics are implemented through, for example, an exchange accounting kernel that tracks per-vertex sector membership and inter-sector curvature flow and verifies a discrete conservation law per cycle, and a stagnation detection kernel that monitors exchange rates and flags exchange-stagnated regions.

In an aspect of an embodiment, total complexity across all three sectors scales logarithmically with accumulated experience such that total complexity is given by N_total=N_active+N_P+N_B=O(log E), and revision events do not increase total complexity because de-consolidated vertices are reclassified rather than created.

Method embodiments corresponding to foregoing computer system embodiments apply equally to maintaining a three-sector cognitive architecture, enforcing a curvature conservation law, implementing exchange channels, detecting curvature misrouting events, and performing related operations, although such method embodiments are not explicitly restated here. Non-transitory computer-readable medium embodiments storing programming instructions that cause one or more processors to perform corresponding operations are likewise contemplated.

### BRIEF DESCRIPTION OF THE DRAWING FIGURES

FIG. 1 is a block diagram illustrating an overall system architecture comprising multiple subsystems and coupled forward reasoning and background exchange dynamics paths.

FIG. 2 is a block diagram illustrating a cognitive manifold substrate with an associated three-sector decomposition and underlying geometric structures.

FIG. 3 is a block diagram illustrating exchange channels governing curvature flow among sectors with defined directionality and timescale ordering.

FIG. 4 is a block diagram illustrating a multi-layer hallucination detection architecture monitoring distinct geometric misrouting conditions.

FIG. 5 is a block diagram illustrating a GPU-based execution architecture with computational kernels operating on shared manifold data structures.

FIG. 6 is a flow diagram illustrating a sector classification process assigning sector membership based on geometric criteria.

FIG. 7 is a flow diagram illustrating a consolidation process through relaxation, boundary accumulation, and reservoir formation.

FIG. 8 is a flow diagram illustrating a reflux process including mismatch accumulation, barrier reduction, and curvature redistribution.

FIG. 9 is a flow diagram illustrating a conservation enforcement cycle verifying consistency between curvature redistribution and injected curvature.

FIG. 10 is a flow diagram illustrating an epistemic horizon detection process based on exchange channel saturation conditions.

FIG. 11 is a flow diagram illustrating an output generation and expression control process based on admissibility, misrouting detection, and horizon classification.

FIG. 12 illustrates an exemplary computing environment on which an embodiment described herein may be implemented.

### DETAILED DESCRIPTION OF THE INVENTION

The inventor has conceived and reduced to practice a system and method for conservation-governed cognitive processing in which reasoning, learning, consolidation of knowledge, revision of prior conclusions, and detection of unreliable reasoning occur within a persistent geometric representation referred to as a cognitive manifold. In an embodiment, cognitive states correspond to locations on a manifold and reasoning corresponds to traversal along trajectories through that manifold. A computer system executing software instructions may maintain a cognitive architecture comprising an active sector supporting reasoning traversal, an irreversible sector storing consolidated knowledge reservoirs, and a boundary sector mediating exchange between active reasoning and consolidated knowledge. Operation of such system may be governed by a conservation relationship applied to curvature energy distributed across sectors of the manifold. Curvature associated with reasoning and knowledge representation may be redistributed among sectors through exchange dynamics including consolidation, restructuring, boundary accumulation, and reflux. Hallucination conditions may be detected as curvature misrouting events in which curvature flows through an incorrect exchange channel or fails to reach an appropriate destination. Through these operations a computing system may coordinate reasoning traversal, knowledge consolidation, revision dynamics, and reliability monitoring under a unified conservation-governed framework.

In an embodiment, cognitive processing occurs within a persistent cognitive manifold denoted for example as M*. Cognitive manifold M* may represent a geometric substrate for cognitive operations in which relationships among cognitive states are encoded using multiple mutually compatible geometric structures. In an embodiment such structures may include a Riemannian semantic metric denoted for example as g, an almost-complex structure denoted as J satisfying a relation such as J²=−Id, a symplectic form denoted as ω satisfying a closedness relation such as dω=0 and compatibility relation such as ω(X, Y)=g(JX, Y), and an epistemic line bundle L→M* equipped with a connection A whose curvature may be expressed for example as F=dA. Such structures may form an almost-Kähler compatibility structure (g, J, ω). Curvature associated with connection A may measure evidential coherence accumulated along reasoning paths through the manifold. In an embodiment a Nijenhuis tensor denoted N_J may measure failure of J to be integrable and may serve as a coupling strain diagnostic indicating regions undergoing structural reorganization.

In an embodiment cognitive manifold M* may be realized using a discrete representation such as a simplicial complex denoted for example as G=(V, E, F), where vertices V represent cognitive states, edges E represent semantic adjacency relations, and faces F represent local neighborhoods. Per-vertex storage may include semantic coordinates representing metric g and parameters describing almost-complex structure J. Per-edge storage may include epistemic phase values denoted for example as θ(i,j) belonging to an interval such as (−π, π], satisfying antisymmetry relation θ(j,i)=−θ(i,j). Discrete epistemic curvature may be computed on a face f as an oriented sum such as F_f=θ(i,j)+θ(j,k)+θ(k,i) (mod 2π). Epistemic holonomy accumulated along a reasoning trajectory γ may be computed for example as Φ(γ)=Σ θ(v_l, v_(l+1)) (mod 2π), representing a Wilson loop around a closed path. Such representation may allow a computing system to monitor evidential coherence of reasoning trajectories during traversal of the manifold.

In an embodiment cognitive manifold M* may be partitioned into three sectors corresponding to distinct geometric regimes. Such sectors may include an active sector, an irreversible sector, and a boundary sector. Active sector may correspond to a portion of manifold M* excluding irreversible and boundary regions, expressed for example as M_active=M* \(P∪B). Active sector may support reasoning traversal and may exhibit nonzero epistemic curvature magnitude |F| and elevated Nijenhuis tensor magnitude ∥N_J∥ indicating structural strain associated with new information processing.

In an embodiment irreversible sector may comprise a disjoint union of consolidated knowledge reservoirs expressed for example as P= [symbol] U_α, where α identifies individual reservoirs. Each reservoir region U_α may satisfy consolidation conditions including phase flatness such that sup |F|p≤ε_R for p within reservoir region U_α, barrier energy at boundary ∂U_α satisfying a relation such as E(∂U_α)≥E*, and admission control at reservoir boundary that permits compatible cognitive states to enter reservoir interior while excluding incompatible states. Within reservoir interiors the almost-complex structure J may approach integrability, such that Nijenhuis tensor magnitude ∥N_J∥ approaches zero and geometry approximates Kähler structure. Epistemic connection within reservoir interior may become approximately flat as exportable curvature migrates outward during consolidation. In an embodiment reservoirs may form an archipelago of isolated knowledge structures in which no direct exchange channel exists between distinct reservoirs without traversal through active and boundary sectors.

In an embodiment boundary sector may correspond to a set of tubular neighborhoods surrounding reservoir boundaries, expressed for example as B=∪T_δ(∂U_α) where T_δ denotes a neighborhood of width δ around boundary ∂U_α. Boundary sector may carry concentrated curvature and may mediate exchange between active and irreversible sectors. Barrier energy associated with boundary sector may represent energetic resistance to perturbation of consolidated knowledge and may accumulate as curvature migrates from active sector toward reservoirs.

In an embodiment sector membership may be determined dynamically by evaluating geometric quantities derived from manifold structures. For example, vertices may be classified as belonging to irreversible sector when local curvature magnitude satisfies |F|≤ε_R and boundary energy exceeds threshold E*. Vertices within tubular neighborhoods surrounding reservoir boundaries may be classified as belonging to boundary sector. Remaining vertices may be classified as belonging to active sector. Sector classification may be updated incrementally as manifold geometry evolves during cognitive processing.

In an embodiment operation of computing system may be governed by a curvature conservation law constraining redistribution of curvature energy among sectors. Total curvature energy may be defined for example as E_total=E_M_active+E_B+E_P, where E_M_active denotes curvature energy in active sector, E_B denotes barrier energy associated with boundaries, and E_P denotes residual curvature energy within reservoir interiors. Active sector curvature energy may include contributions such as semantic curvature energy |Riem(g)|², epistemic curvature energy |F|², and Nijenhuis energy ∥N_J∥².

Conservation relationship may be expressed for example as dE_total/dt=Φ_ext(t), where Φ_ext(t) represents curvature injected by projection of new external experience into manifold M*. A discrete form of the conservation law may be expressed for example as ΔE_total =ΔE_M_active+ΔE_B+ΔE_P=Φ_ext. where Δ denotes change per computational cycle. A computing system may verify conservation relationship by computing per-cycle curvature changes across sectors and comparing aggregated change to curvature injected by projection operator within a numerical tolerance.

In an embodiment curvature redistribution among sectors may occur through exchange channels. A consolidation channel may transport curvature from active sector through boundary sector into irreversible sector, representing learning and consolidation of knowledge. Consolidation may proceed through stages including epistemic relaxation in which connection relaxation flow reduces curvature magnitude |F| within active sector, curvature migration through edges adjacent to boundary sector, barrier accumulation in which migrated curvature increases barrier energy at reservoir boundaries, and exchange equilibrium in which exportable curvature has migrated outward and reservoir interior achieves approximate phase flatness. Interior curvature after equilibrium may satisfy a relation for example such as |F|_int≤σ²_ev/(2 η_R λ_R), where σ²_ev represents evidence variance, η_R represents relaxation rate, and λ_R represents spectral gap of connection Laplacian.

In an embodiment restructuring channel may redistribute curvature within active sector between semantic curvature associated with metric g and epistemic curvature associated with connection A. Such redistribution may be constrained by compatibility relationships imposed by almost-complex structure J and symplectic form ω. Restructuring channel may operate at a faster timescale denoted for example as τ_C, allowing reinterpretation of existing knowledge structures without exporting curvature to irreversible sector.

In an embodiment boundary accumulation channel may concentrate curvature from active sector into boundary sector without completing transfer into irreversible sector. Such accumulation may strengthen barrier energy protecting consolidated knowledge while evidence continues to accumulate. Boundary accumulation may operate at an intermediate timescale denoted for example as τ_R.

In an embodiment reflux channel may transport curvature from irreversible sector through boundary sector back into active sector when revision of consolidated knowledge is required. Reflux may occur when contradictory evidence produces holonomy mismatch between reservoir content and newly projected information. When accumulated mismatch exceeds threshold determined by barrier energy, reservoir boundary may weaken and curvature may flow back into active sector. Reflux channel may occur at a slower timescale τ_reflux such that τ_C <τ_R<<τ_reflux. Energetic asymmetry may exist in which consolidation gradually builds barrier energy while reflux requires overcoming accumulated barrier energy. For example reflux activation energy may be proportional to barrier energy, such as requiring perturbation energy on the order of approximately 0.63×E* to initiate revision.

In an embodiment consolidation may be energetically forced as a consequence of exchange equilibrium under the conservation law. Reservoir interior flatness may emerge because exportable curvature migrates outward until equilibrium is reached. Barrier energy may arise as curvature accumulates at boundaries under conservation constraints. Admission control may emerge as a physical consequence of barrier energy preventing low-energy perturbations from entering reservoir interiors.

In an embodiment hallucination conditions may be detected as curvature misrouting events. Channel bypass may occur when curvature crosses a topological barrier without traversing a legitimate exchange channel. Detection may involve maintaining a barrier-edge bitmap identifying edges that cross sector boundaries and monitoring curvature transport across those edges without corresponding exchange accounting. Curvature laundering may occur when epistemic curvature |F|² becomes concealed within semantic curvature |Riem(g)|², producing semantic structure lacking evidential grounding. Detection may involve monitoring epistemic holonomy Φ(γ) along reasoning trajectories and identifying phase drift exceeding threshold Φ*. Premature export may occur when curvature is consolidated into irreversible sector before exchange equilibrium is achieved. Detection may involve monitoring symplectic capacity density expressed for example as ρ_ω(i)=|N_k(i)|/c_ω(i) where c_ω(i) represents local symplectic capacity derived from symplectic form ω, preventing export when density exceeds threshold derived from symplectic non-squeezing constraints. Blocked export may occur when curvature remains trapped in active sector due to saturation of exchange channels.

In an embodiment computing system may monitor exchange flow rates among sectors to identify stagnation conditions. Regions in which curvature remains unchanged despite external forcing Φ_ext, Nijenhuis tensor magnitude remains maximal, and boundary sectors remain saturated may be identified as exchange-stagnated regions. Such conditions may correspond to epistemic horizons representing connected regions where curvature is trapped and dynamics stall.

In an embodiment exchange dynamics may be implemented on parallel processing hardware such as graphics processing units. Computational kernels may operate on shared manifold data structures representing simplicial complex G. For example, an exchange accounting kernel referred to for example as K4 may track sector membership of vertices and compute inter-sector curvature flow, verifying discrete conservation relation ΔE_total=Φ_ext per cycle. A stagnation detection kernel referred to for example as K5 may analyze curvature flow statistics produced by kernel K4 and identify exchange-stagnated regions corresponding to blocked export or epistemic horizon formation.

In an embodiment reasoning results may be decoded for output only when reasoning trajectories remain epistemically admissible and curvature misrouting conditions are not detected. When misrouting events occur computing system may suppress output or produce qualified responses indicating epistemic insufficiency. Admissible reasoning trajectories may be consolidated into reservoir structures and recorded for reuse in future reasoning cycles.

Through coordinated operation of manifold maintenance, sector classification, conservation enforcement, exchange channel dynamics, misrouting detection, stagnation monitoring, and output conditioning, computing system may implement conservation-governed cognitive processing in which reasoning traversal, knowledge consolidation, revision of prior conclusions, and hallucination detection are governed by curvature exchange dynamics within a persistent geometric manifold.

In a non-limiting use case example, a computer system implementing a conservation-governed cognitive architecture operates as an analytical assistant for a scientific research organization evaluating evidence relating to interactions between two biological signaling pathways. Researchers provide experimental results indicating that a protein complex previously associated with one signaling pathway may influence activity in a second pathway. Input data describing experimental observations, publications, and contextual scientific information is received by a computing system and projected into a cognitive manifold as a provisional cognitive state. Projection of such input may inject curvature into an active sector of the manifold, which may be recorded for example as curvature flux Φ_ext associated with introduction of new experience into the system.

After projection, sector classification may evaluate geometric quantities associated with the projected cognitive state. Epistemic curvature magnitude |F|, Nijenhuis tensor magnitude ∥N_J∥, and proximity to boundaries of consolidated knowledge reservoirs may be computed from manifold structures stored in memory. Because the experimental relationship between the two signaling pathways has not previously been consolidated, a projected state may be classified as belonging to an active sector rather than to an irreversible sector or a boundary sector. Reasoning may then proceed as traversal of trajectories within the active sector of the manifold.

During reasoning traversal, a computing system may evaluate epistemic holonomy along candidate trajectories representing alternative explanations of the experimental data. For example, a trajectory γ connecting cognitive states describing the two signaling pathways may accumulate phase according to a relation such as Φ(γ)=Σ θ(v_l, v_(l+1)) (mod 2π). If accumulated phase drift remains below a threshold Φ*, the trajectory may remain epistemically coherent and reasoning may continue. If phase drift exceeds such threshold, a curvature laundering condition may be detected, indicating that semantic relationships are being inferred without adequate evidential support.

As reasoning progresses, curvature associated with provisional knowledge may redistribute according to exchange channel dynamics. For example, restructuring dynamics may redistribute curvature within the active sector between semantic curvature associated with semantic metric g and epistemic curvature associated with connection A. Such restructuring may correspond to reinterpretation of experimental results in light of previously known biological mechanisms.

If subsequent experimental data confirms the hypothesized interaction between pathways, epistemic curvature associated with the region of the manifold representing the interaction may decrease under connection relaxation dynamics. Curvature migration toward a boundary sector may occur as exportable curvature moves outward through edges adjacent to reservoir boundaries. Curvature accumulation at such boundaries may increase barrier energy associated with those boundaries.

When consolidation conditions are satisfied, for example when curvature magnitude |F|within the region falls below a flatness threshold ε_R and barrier energy at the region boundary exceeds a threshold E*, the region may transition into a consolidated reservoir within an irreversible sector. Within such reservoir interior, epistemic curvature may approach flatness and Nijenhuis tensor magnitude may decrease toward zero, indicating a stable geometric configuration representing consolidated scientific knowledge.

In another scenario within the same system, researchers may later introduce new experimental evidence contradicting the previously consolidated interpretation. Projection of contradictory evidence may introduce new curvature into the active sector. As reasoning trajectories traverse boundary regions surrounding the reservoir, holonomy mismatch may occur between newly introduced curvature and existing reservoir geometry. When accumulated mismatch exceeds a threshold determined by barrier energy of the reservoir boundary, reflux dynamics may activate. Curvature may then flow from the reservoir through the boundary sector back into the active sector, allowing the system to revise the previously consolidated interpretation.

During operation, hallucination detection may occur simultaneously through monitoring of curvature misrouting events. For example, if a reasoning trajectory attempts to cross a barrier edge without corresponding exchange accounting consistent with conservation law ΔE_total=ΔE_M_active+ΔE_B+ΔE_P=Φ_ext, a channel bypass condition may be detected. If epistemic curvature |F|² becomes concealed within semantic curvature |Riem(g)|² while phase monitoring reveals excessive holonomy drift, a curvature laundering condition may be detected. If curvature export into an irreversible sector occurs while symplectic capacity density ρ_ω(i)=|N_k(i)|/c_ω(i) exceeds an allowable threshold derived from symplectic constraints, a premature export condition may be identified. Alternatively, if curvature remains trapped in the active sector while evidence flux continues and adjacent boundary regions are saturated with barrier energy, blocked export may be detected and region may be classified as an exchange-stagnated region.

When an exchange-stagnated region persists across multiple computational cycles, the system may classify the region as an epistemic horizon. Such classification may indicate that current manifold geometry cannot resolve uncertainty without additional evidence. Output generation may then provide a qualified response indicating that available evidence does not support a definitive conclusion, rather than generating a speculative answer unsupported by consolidated knowledge.

In such use case example, system operation demonstrates how conservation-governed exchange dynamics regulate reasoning traversal, knowledge consolidation, revision, and reliability monitoring within a unified geometric framework. External evidence injected into the system influences curvature within the active sector, consolidation occurs when exchange equilibrium is reached, revision occurs through reflux dynamics when contradictory evidence accumulates, and hallucination conditions are detected as curvature misrouting events within the manifold representation.

The foregoing use case examples are non-limiting in nature and is provided solely to illustrate one possible mode of operation of a system implementing conservation-governed cognitive processing as described herein. Numerous other use cases and operational environments may exist in which embodiments of the disclosed architecture may be employed. For example, implementations may support scientific analysis systems that evaluate experimental evidence across multiple disciplines, decision-support systems that assist in policy, regulatory, or financial analysis, engineering design environments that reason about complex system interactions, medical or biomedical research platforms that integrate heterogeneous experimental results, or knowledge management systems that maintain persistent reasoning structures across extended periods of operation. Embodiments may also be applied to autonomous analytical agents, multimodal reasoning systems integrating textual, visual, and sensor-derived data, distributed cognitive systems operating across multiple computing nodes, or enterprise knowledge infrastructures in which long-horizon reasoning and reliability of conclusions are desirable. The particular use case described above therefore should not be interpreted as limiting the scope of the invention. Rather, it is intended to demonstrate general operation of a computer system in which reasoning, knowledge consolidation, revision dynamics, and detection of unreliable reasoning trajectories occur within a geometric manifold governed by conservation-governed curvature exchange dynamics. Other arrangements, data sources, computational environments, and application domains may be used while remaining within the scope of the disclosed systems and methods.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “active sector” refers to a region of a cognitive manifold in which cognitive states evolve through reasoning traversal and in which semantic curvature, epistemic curvature, or coupling strain may vary as new information is incorporated into the system.

As used herein, “almost-complex structure” refers to a geometric structure defined on tangent spaces of a manifold that assigns a linear map whose square equals negative identity, such that the structure constrains admissible deformations of the manifold geometry.

As used herein, “almost-Kähler compatibility” refers to a compatibility condition among a Riemannian semantic metric, an almost-complex structure, and a symplectic form on a manifold in which the symplectic form may be reconstructed from the semantic metric and the almost-complex structure and remains closed under exterior differentiation.

As used herein, “barrier energy” refers to an energy quantity associated with a boundary of a consolidated knowledge reservoir that represents resistance to perturbation of the reservoir interior by curvature originating outside the reservoir.

As used herein, “boundary sector” refers to a region of a cognitive manifold that surrounds boundaries of consolidated knowledge reservoirs and mediates exchange of curvature between an active sector and an irreversible sector.

As used herein, “channel bypass” refers to a curvature misrouting condition in which curvature crosses a sector boundary without traversing an authorized exchange pathway between sectors.

As used herein, “cognitive manifold” refers to a geometric representation within which cognitive states correspond to locations and reasoning processes correspond to trajectories through the manifold.

As used herein, “cognitive state” refers to a representational configuration corresponding to a point or vertex in a cognitive manifold representing knowledge, hypotheses, interpretations, or intermediate reasoning outcomes.

As used herein, “consolidation channel” refers to an exchange pathway through which curvature migrates from an active sector through a boundary sector into an irreversible sector during consolidation of knowledge.

As used herein, “conservation law” refers to a computational constraint applied to curvature energy such that curvature redistributed among sectors of a cognitive manifold remains equal to curvature introduced through projection of new information within numerical tolerance.

As used herein, “curvature” refers to a quantity derived from geometric structures of a cognitive manifold, including semantic curvature associated with a Riemannian metric and epistemic curvature associated with a connection on an epistemic line bundle.

As used herein, “curvature laundering” refers to a hallucination condition in which epistemic curvature representing evidential inconsistency becomes concealed within semantic curvature representing structural relationships between cognitive states.

As used herein, “curvature misrouting” refers to a condition in which curvature flows through an incorrect exchange pathway or remains trapped in an inappropriate region of a cognitive manifold.

As used herein, “exchange channel” refers to a mechanism through which curvature energy is redistributed between sectors of a cognitive manifold.

As used herein, “exchange equilibrium” refers to a state in which exportable curvature from an active sector has migrated toward reservoir boundaries and interior curvature of a consolidated region approaches flatness.

As used herein, “exchange stagnation” refers to a condition in which curvature cannot redistribute through available exchange channels despite continued evidence injection.

As used herein, “epistemic connection” refers to a geometric structure that assigns phase values to transitions between cognitive states and whose curvature measures evidential coherence of reasoning paths.

As used herein, “epistemic horizon” refers to a connected region of an active sector in which curvature becomes trapped, exchange channels are saturated, and reasoning dynamics stall.

As used herein, “epistemic holonomy” refers to accumulated phase associated with traversal of a reasoning trajectory through a cognitive manifold.

As used herein, “epistemic line bundle” refers to a bundle structure over a cognitive manifold in which each location carries an evidential state whose phase evolves under parallel transport along reasoning trajectories.

As used herein, “epistemic phase” refers to a scalar value accumulated along a reasoning trajectory representing evidential drift measured by a connection on an epistemic line bundle.

As used herein, “irreversible sector” refers to a region of a cognitive manifold comprising consolidated knowledge reservoirs whose internal curvature is below a flatness threshold and whose boundaries possess barrier energy sufficient to resist perturbation.

As used herein, “knowledge reservoir” refers to a consolidated region of a cognitive manifold representing stabilized knowledge characterized by low internal curvature and protected by boundary barrier energy.

As used herein, “Nijenhuis tensor” refers to a tensor that measures the failure of an almost-complex structure to be integrable and that may serve as a diagnostic of coupling strain within a cognitive manifold.

As used herein, “premature export” refers to a curvature misrouting condition in which curvature is transferred into an irreversible sector before exchange equilibrium has been reached.

As used herein, “projection operator” refers to a computational mechanism that maps external input or newly generated representations into locations on a cognitive manifold.

As used herein, “reflux channel” refers to an exchange pathway through which curvature flows from an irreversible sector back into an active sector when revision of consolidated knowledge is required.

As used herein, “restructuring channel” refers to an exchange pathway through which curvature redistributes within an active sector between semantic and epistemic components without transferring curvature into an irreversible sector.

As used herein, “semantic curvature” refers to curvature derived from a Riemannian semantic metric representing structural relationships among cognitive states.

As used herein, “semantic metric” refers to a Riemannian metric defined on a cognitive manifold that measures semantic dissimilarity between cognitive states.

As used herein, “sector” refers to a region of a cognitive manifold characterized by distinct geometric properties and exchange dynamics.

As used herein, “sector classification” refers to a process of assigning locations within a cognitive manifold to an active sector, boundary sector, or irreversible sector based on geometric properties.

As used herein, “simplicial complex” refers to a discrete representation of a manifold comprising vertices, edges, and higher-dimensional faces used to represent geometric relationships among cognitive states.

As used herein, “symplectic capacity” refers to a quantity derived from a symplectic form that constrains the minimum volume required to represent consolidated knowledge within a manifold.

As used herein, “symplectic form” refers to a closed non-degenerate bilinear form compatible with a semantic metric and an almost-complex structure that provides rigidity to geometric representations.

As used herein, “thermodynamic asymmetry” refers to a property of exchange dynamics in which consolidation of knowledge occurs with lower energetic cost than revision of previously consolidated knowledge.

### Conceptual Architecture of a Conservation-Governed Cognitive Processing System

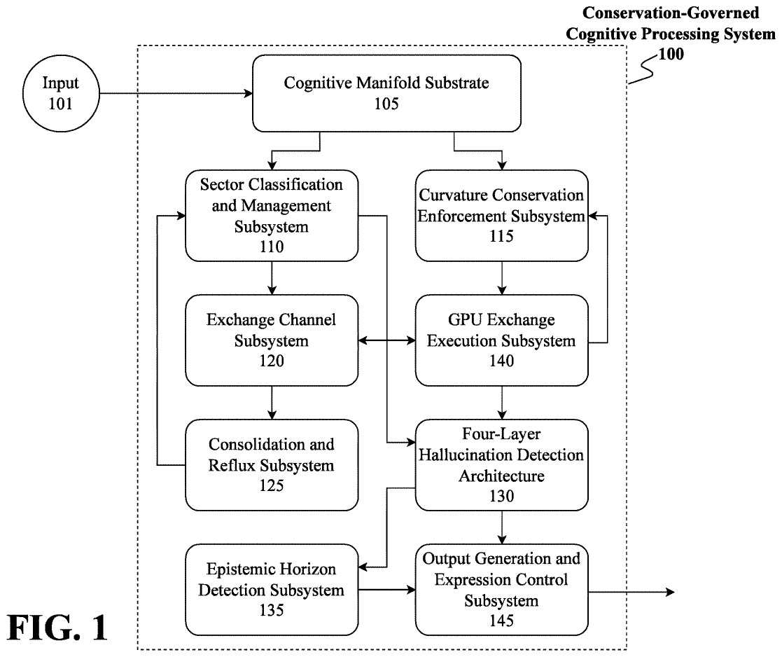

FIG. 1 is a block diagram illustrating exemplary architecture of a conservation-governed cognitive processing system 100, in an embodiment. System 100 as illustrated comprises a cognitive manifold substrate 105, a sector classification and management subsystem 110, a curvature conservation enforcement subsystem 115, an exchange channel subsystem 120, a consolidation and reflux subsystem 125, a four-layer hallucination detection architecture 130, an epistemic horizon detection subsystem 135, a GPU exchange execution subsystem 140, and an output generation and expression control subsystem 145. Data input 101 represents external cognitive input that may be processed by input projection mechanisms described in incorporated parent applications and projected into a cognitive manifold at the start of each processing cycle, injecting curvature that initiates exchange dynamics. System 100 supports two concurrent processing paths: a forward path through which projected input is reasoned about and decoded into output, and a background exchange path through which curvature is redistributed among sectors of a cognitive manifold under a curvature conservation law, with these paths coupled such that exchange dynamics condition geometry available to forward-path reasoning and forward-path processing injects curvature that drives exchange dynamics.

A cognitive manifold substrate 105 maintains a persistent geometric representation within which cognitive operations in system 100 occur. A cognitive manifold substrate 105 stores four mutually compatible geometric structures: a Riemannian semantic metric, an almost-complex structure, a compatible symplectic form, and an epistemic line bundle with connection. These structures together constitute an epistemically conditioned almost-Kähler manifold. Per-vertex and per-edge geometric quantities maintained by a cognitive manifold substrate 105, including epistemic curvature magnitude, Nijenhuis tensor magnitude, and per-edge epistemic phase values, are provided to downstream subsystems at each cognitive cycle. A cognitive manifold substrate 105 may be realized as a simplicial complex on GPU hardware and may be updated on separated timescales corresponding to input projection, compression flow, and connection relaxation. Updated geometric state is provided to a sector classification and management subsystem 110 and a curvature conservation enforcement subsystem 115 as primary inputs to forward-path reasoning and exchange dynamics.

A sector classification and management subsystem 110 partitions a cognitive manifold into an active sector, a boundary sector, and an irreversible sector based on local geometric properties read from a cognitive manifold substrate 105, including epistemic curvature magnitude, barrier energy derived from curvature accumulation at reservoir boundaries, Nijenhuis tensor magnitude, and proximity to known reservoir boundaries. Vertices satisfying phase flatness and barrier energy criteria are classified as belonging to an irreversible sector, vertices within tubular neighborhoods of reservoir boundaries are classified as belonging to a boundary sector, and remaining vertices are classified as belonging to an active sector supporting reasoning traversal. Reasoning traversal within an active sector may be performed by trajectory traversal mechanisms operating on the manifold representation, including mechanisms described in incorporated parent applications. A sector classification and management subsystem 110 maintains a barrier-edge bitmap identifying edges that cross sector boundaries and provides sector maps and the barrier-edge bitmap to an exchange channel subsystem 120, a curvature conservation enforcement subsystem 115, and a four-layer hallucination detection architecture 130. Sector classification is updated incrementally at each cognitive cycle as manifold geometry evolves, with reclassification triggered by changes in local geometric properties recorded in a cognitive manifold substrate 105.

A curvature conservation enforcement subsystem 115 enforces a curvature conservation law by computing per-cycle changes in curvature energy across all three sectors and comparing an aggregated change to curvature injected by a projection operator. In absence of new external experience, a curvature conservation enforcement subsystem 115 verifies that curvature is redistributed among sectors rather than created or destroyed. When a discrepancy between aggregated curvature change and injected curvature exceeds a numerical tolerance, a curvature conservation enforcement subsystem 115 flags the discrepancy and routes a diagnostic record to a GPU exchange execution subsystem 140. Per-sector curvature budgets and exchange balance statistics produced by a curvature conservation enforcement subsystem 115 are provided to an exchange channel subsystem 120 to support physically consistent curvature flow among sectors.

An exchange channel subsystem 120 governs redistribution of curvature among the three sectors through four exchange pathways: a consolidation channel transporting curvature from an active sector through a boundary sector into an irreversible sector, a restructuring channel redistributing curvature within an active sector between semantic and epistemic components, a boundary accumulation channel concentrating curvature from an active sector into a boundary sector, and a reflux channel transporting curvature from an irreversible sector back through a boundary sector into an active sector. These channels operate at ordered timescales reflecting energetic asymmetry, such that a restructuring channel operates at a fast timescale, a consolidation channel and boundary accumulation channel operate at an intermediate timescale, and a reflux channel operates at a substantially slower timescale determined by accumulated barrier energy. An exchange channel subsystem 120 receives per-sector curvature budgets from a curvature conservation enforcement subsystem 115 and sector maps from a sector classification and management subsystem 110, and exchange dynamics may be executed through a GPU exchange execution subsystem 140. A consolidation and reflux subsystem 125 manages reservoir lifecycle in coordination with an exchange channel subsystem 120, evaluating consolidation readiness, gating reservoir formation on derived equilibrium conditions, and executing localized reflux when holonomy mismatch at a reservoir boundary exceeds a threshold determined by barrier energy, with updated reservoir boundaries and sector membership labels communicated to a sector classification and management subsystem 110 upon each consolidation or reflux event.

A GPU exchange execution subsystem 140 implements exchange dynamics on GPU hardware through two computational kernels operating within a persistent CUDA graph. An exchange accounting kernel designated K4 tracks per-vertex sector membership and inter-sector curvature flow and verifies a discrete conservation law per cycle, providing running exchange balance statistics to a curvature conservation enforcement subsystem 115 and per-channel curvature flow rates to a four-layer hallucination detection architecture 130. A stagnation detection kernel designated K5 reads exchange rate statistics from K4 and identifies exchange-stagnated regions where all exchange channels from a region are simultaneously saturated, providing stagnation indicators to an epistemic horizon detection subsystem 135 and to layer 4 of a four-layer hallucination detection architecture 130. Combined computational overhead of kernels K4 and K5 may be on the order of less than ten percent of an existing computational pipeline.

A four-layer hallucination detection architecture 130 detects hallucination conditions as curvature misrouting events through four concurrent detection layers that together may identify hallucination types undetectable by any individual layer in isolation. Layer 1 monitors a barrier-edge bitmap from a sector classification and management subsystem 110 for channel bypass events, in which curvature crosses a sector boundary absent exchange accounting consistent with a conservation law. Layer 2 monitors epistemic holonomy accumulated along active reasoning trajectories for curvature laundering events, in which epistemic curvature becomes concealed within semantic curvature, and may operate at a monitoring rate on the order of at least one evaluation per characteristic laundering timescale. Layer 3 monitors symplectic capacity density at reservoir boundaries for premature export events, in which curvature is transferred into an irreversible sector before exchange equilibrium is reached, and may hold affected curvature in a boundary sector until equilibrium conditions are satisfied. Layer 4 reads per-sector curvature flow rates from a GPU exchange execution subsystem 140 to detect blocked export events, in which curvature remains trapped in an active sector due to simultaneous saturation of all exchange channels from a region. Misrouting flags from all four layers are forwarded to an output generation and expression control subsystem 145, and saturation indicators from layer 4 are also forwarded to an epistemic horizon detection subsystem 135.

An epistemic horizon detection subsystem 135 identifies connected regions of an active sector where all exchange channels are simultaneously saturated, curvature is trapped, coupling strain is maximal, and dynamics have stalled across consecutive cognitive cycles. An epistemic horizon detection subsystem 135 augments saturation indicators from layer 4 of a four-layer hallucination detection architecture 130 with connected-component analysis over an active sector graph to determine spatial extent of each candidate horizon. Each identified horizon may be evaluated to determine whether it may be resolved through introduction of new evidence that opens exchange pathways, through modification of boundary structure or exchange pathways, or whether it represents an irreducible epistemic limitation of current manifold geometry. Horizon classifications and severity metrics are communicated to an output generation and expression control subsystem 145 to condition output generation and to an exchange channel subsystem 120 for potential intervention.

An output generation and expression control subsystem 145 determines whether completed reasoning trajectories are eligible for decoding based on epistemic admissibility, misrouting flags from a four-layer hallucination detection architecture 130, and horizon classifications from an epistemic horizon detection subsystem 135. When an output eligibility determination is affirmative and no misrouting flags are active for a completed trajectory, an output generation and expression control subsystem 145 invokes manifold-conditioned decoding to map admissible cognitive states into external representations such as natural language responses, symbolic structures, or executable actions. When a misrouting flag is active, an output generation and expression control subsystem 145 may generate a qualified response derived from an admissible prefix of a reasoning trajectory, accompanied by structured indications of epistemic insufficiency corresponding to a detected misrouting type and a location of an exchange violation in a sector map. When no admissible prefix is available, an output generation and expression control subsystem 145 may suppress decoding and generate a suppression response rather than emit content derived from an inadmissible trajectory, with suppression implemented as a defined architectural state within system 100.

In an embodiment, data flows through system 100 along two concurrent paths that are coupled through shared manifold state. External input received at data input 101 is processed by projection mechanisms described in incorporated parent applications and projected into a cognitive manifold substrate 105 as a provisional cognitive state, injecting curvature recorded by a GPU exchange execution subsystem 140 as a conservation forcing term for a current cycle. A sector classification and management subsystem 110 evaluates a projected state against sector membership criteria and a barrier-edge bitmap, and an admitted state enters an active sector for reasoning traversal. During traversal, a four-layer hallucination detection architecture 130 operates concurrently, with layer 1 reading a barrier-edge bitmap, layer 2 accumulating epistemic holonomy along a traversed trajectory, layer 3 monitoring symplectic capacity density at sector boundaries, and layer 4 reading per-sector exchange flow rates from a GPU exchange execution subsystem 140, with any misrouting flags forwarded to an output generation and expression control subsystem 145. Concurrently, exchange dynamics evolve on separated timescales through an exchange channel subsystem 120, with a restructuring channel operating at a fast timescale within an active sector and a consolidation channel and boundary accumulation channel transporting curvature toward reservoir boundaries at an intermediate timescale, while a curvature conservation enforcement subsystem 115 verifies a discrete conservation law at a close of each cycle and provides updated per-sector budgets to an exchange channel subsystem 120. A consolidation and reflux subsystem 125 evaluates consolidation readiness for active sector regions approaching equilibrium and, upon satisfied conditions, commits a region to an irreversible sector and notifies a sector classification and management subsystem 110 to update sector membership labels and a barrier-edge bitmap for subsequent cycles; when reflux is warranted, a consolidation and reflux subsystem 125 weakens an affected reservoir boundary, releasing curvature back into an active sector, and a curvature conservation enforcement subsystem 115 updates per-sector budgets accordingly. Completed trajectories are routed to an output generation and expression control subsystem 145, which computes an output eligibility determination and invokes or suppresses decoding based on admissibility status and any active misrouting or horizon flags, forwarding a resulting output to an external interface.

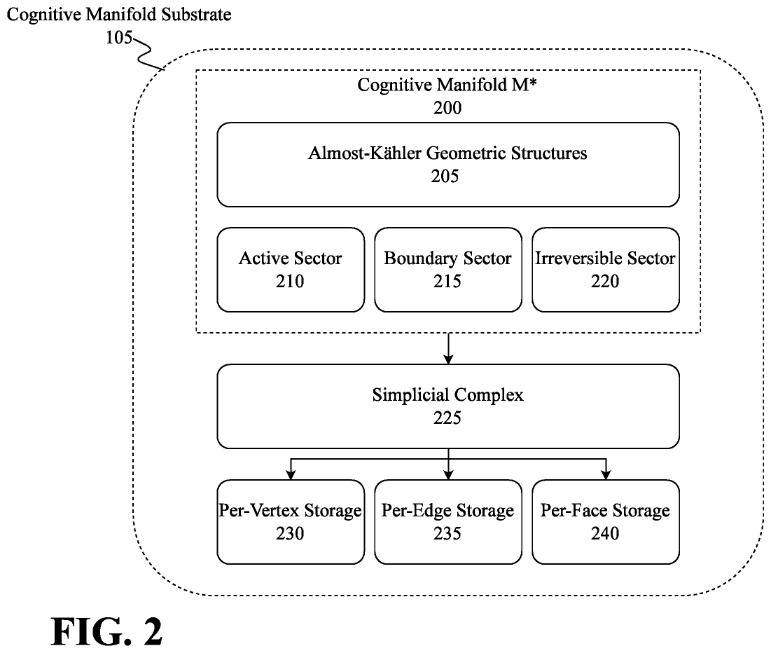

FIG. 2 is a block diagram illustrating an exemplary cognitive manifold substrate 105 and three-sector decomposition of a cognitive manifold M* 200, in an embodiment. A cognitive manifold M* 200 represents a persistent geometric representation within which cognitive operations of system 100 occur. A cognitive manifold M* 200 comprises a set of almost-Kähler geometric structures 205 and decomposes into three sectors: an active sector 210, a boundary sector 215, and an irreversible sector 220. Each sector occupies a distinct region of a cognitive manifold M* 200 and characterized by distinct geometric properties. A cognitive manifold M* 200 may be realized as a simplicial complex G=(V, E, F) 225 stored on GPU hardware with a persistent CUDA graph, with geometric state distributed across per-vertex storage 230, per-edge storage 235, and per-face storage 240.

Almost-Kähler geometric structures 205 comprise four mutually compatible geometric components maintained across a cognitive manifold M* 200: a Riemannian semantic metric g, in which geodesic distance measures semantic dissimilarity between cognitive states; an almost-complex structure J satisfying J²=−Id, which constrains admissible deformations of manifold geometry; a compatible symplectic form ω satisfying dω=0 and the compatibility relation ω(X, Y)=g(JX, Y); and an epistemic line bundle connection A whose curvature F=dA measures evidential coherence accumulated along reasoning trajectories. A Nijenhuis tensor N_J, derived from J, measures failure of J to be integrable and serves as a coupling strain diagnostic accessible to sector classification and hallucination detection operations. The almost-Kähler compatibility condition among g, J, and ω constrains admissible geometric deformation of a cognitive manifold M* 200 and regulates how curvature may be redistributed among sectors during exchange dynamics.

An active sector 210 corresponds to the portion of a cognitive manifold M* 200 remaining after an irreversible sector 220 and a boundary sector 215 are excluded, expressed as M_active=M* \(P∪B). An active sector 210 is the region where reasoning occurs as dynamic traversal of a cognitive manifold M* 200 and carries the full almost-Kähler structure with generally nonzero epistemic curvature magnitude |F| and elevated Nijenhuis tensor magnitude ∥N_J∥ at frontier regions associated with newly introduced or evolving cognitive states. New external experience projected into system 100 enters through an active sector 210 via a projection operator that maps incoming input to a provisional cognitive state on a cognitive manifold M* 200.

A boundary sector 215 corresponds to the union of tubular neighborhoods surrounding reservoir boundaries, expressed as B=∪T_δ(∂U_α), where the neighborhood width δ_α is determined by local barrier energy profile derived from curvature accumulation at reservoir boundaries rather than a free parameter. A boundary sector 215 provides the interface through which curvature exchange occurs between an active sector 210 and an irreversible sector 220, such that no curvature may enter or leave a knowledge reservoir without passing through a boundary sector 215. A boundary sector 215 carries concentrated curvature and barrier energy and exhibits intermediate Nijenhuis tensor magnitude, and supports admission control governing curvature entering an irreversible sector 220 and release control governing curvature leaving an irreversible sector 220 during reflux events.

An irreversible sector 220 comprises the disjoint union of consolidated knowledge reservoirs, expressed as P = [symbol] U_α, where each reservoir U_α satisfies conditions including phase flatness such that epistemic curvature magnitude within the reservoir interior satisfies |F|≤ε_R, barrier energy at the reservoir boundary satisfying E(∂U_α)≥E*, and admission control at the reservoir boundary. Within reservoir interiors, the almost-complex structure J approaches integrability such that Nijenhuis tensor magnitude ∥N_J∥ approaches zero and local geometry approximates Kähler structure. No direct exchange channel exists between distinct reservoirs within an irreversible sector 220, such that curvature redistribution between any two reservoirs may occur only through a boundary sector 215 and an active sector 210.

A simplicial complex G=(V, E, F) 225 is the discrete realization of a cognitive manifold M* 200 on GPU hardware operating through a persistent CUDA graph. Per-vertex storage 230 maintains semantic coordinates representing a semantic metric g, per-vertex almost-complex structure parameters J_i, and a sector membership label assigned and updated by a sector classification and management subsystem 110 based on geometric quantities maintained within a cognitive manifold substrate 105. Per-edge storage 235 maintains epistemic phase values θ(i,j) belonging to the interval (−π, π] satisfying the antisymmetry relation θ(j,i)=−θ(i,j), and per-edge curvature flow tracking fields maintained by a GPU exchange execution subsystem 140 to support conservation accounting and exchange monitoring. Per-face storage 240 maintains discrete epistemic curvature F_f computed as the oriented sum θ(i,j)+θ(j,k)+θ(k,i) modulo 2π over each triangular face, along with a symplectic form ω reconstructed per face from g and J according to the compatibility relation ω(X, Y)=g(JX, Y) and verified to satisfy a discrete closedness condition at each update cycle.

In an embodiment, cognitive state information propagates through a cognitive manifold M* 200 as geometric state updates distributed across simplicial complex G=(V, E, F) 225. External input projected into system 100 may be mapped to one or more vertices within per-vertex storage 230, introducing provisional cognitive states and associated curvature into an active sector 210. Reasoning traversal may then proceed as successive transitions between adjacent vertices connected by edges of simplicial complex G=(V, E, F) 225, with epistemic phase values θ(i,j) stored in per-edge storage 235 accumulating along traversed trajectories to produce epistemic holonomy. As trajectories evolve, curvature associated with reasoning activity may redistribute through neighboring vertices, edges, and faces according to geometric compatibility constraints imposed by almost-Kähler geometric structures 205. Regions of the manifold exhibiting decreasing epistemic curvature magnitude |F| and stable geometric structure may migrate toward boundary sector 215, where curvature accumulation contributes to barrier energy at reservoir boundaries. When consolidation conditions are satisfied, regions may transition into irreversible sector 220 as consolidated knowledge reservoirs. Throughout this process, geometric state stored across per-vertex storage 230, per-edge storage 235, and per-face storage 240 provides a continuously updated representation of cognitive state evolution within cognitive manifold M* 200, enabling downstream subsystems to evaluate sector membership, monitor curvature flow, and regulate exchange dynamics during successive processing cycles.

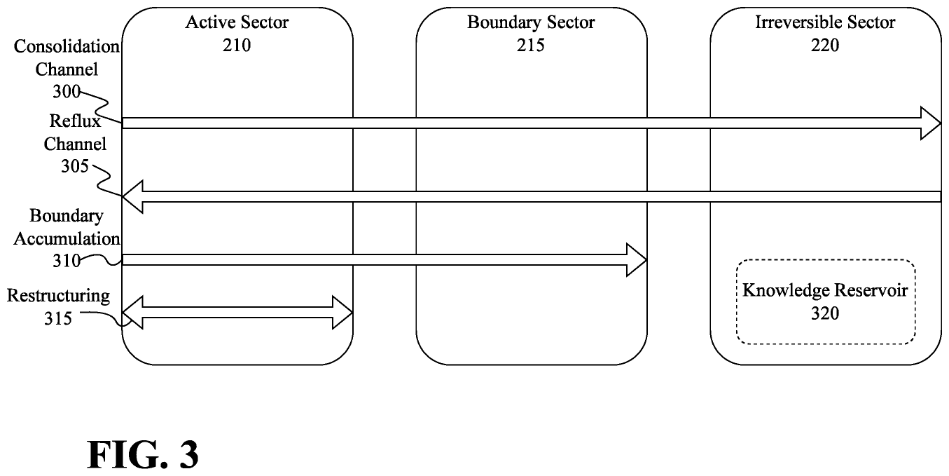

FIG. 3 is a block diagram illustrating exemplary architecture of exchange channels within a cognitive manifold substrate 105, in an embodiment. A cognitive manifold substrate 105 decomposes into three sectors occupying distinct geometric regions: an active sector 210, a boundary sector 215, and an irreversible sector 220. An active sector 210 supports reasoning traversal and carries generally nonzero epistemic curvature magnitude and elevated Nijenhuis tensor magnitude at frontier regions associated with newly introduced cognitive states. A boundary sector 215 provides an interface through which curvature exchange occurs between an active sector 210 and an irreversible sector 220, carrying concentrated curvature and barrier energy at reservoir boundaries derived from curvature accumulation. An irreversible sector 220 comprises consolidated knowledge reservoirs characterized by epistemic curvature magnitude at or below a flatness threshold and Nijenhuis tensor magnitude approaching zero, such that local geometry may approximate a Kähler structure.

An irreversible sector 220 may contain one or more knowledge reservoirs 320, each satisfying conditions including phase flatness, barrier energy at a reservoir boundary at or above a threshold determined by a curvature budget under a curvature conservation law, and admission control at a reservoir boundary that may route compatible cognitive states into a reservoir interior while excluding incompatible states. These conditions may arise as derived consequences of exchange equilibrium under a curvature conservation law rather than as independently imposed design parameters. A knowledge reservoir 320 represents a stabilized geometric region whose internal curvature has migrated outward during consolidation, with resulting barrier energy providing resistance to perturbation by active sector dynamics.

Curvature redistribution among an active sector 210, a boundary sector 215, and an irreversible sector 220 may occur through four exchange channels operating on curvature encoded in geometric state of a cognitive manifold substrate 105. A consolidation channel 300 governs transfer of curvature from an active sector 210 through a boundary sector 215 into an irreversible sector 220, operating at a slow timescale and representing a mechanism by which evidentially coherent cognitive states may be encoded into a knowledge reservoir 320. A reflux channel 305 governs transfer of curvature from an irreversible sector 220 through a boundary sector 215 back into an active sector 210, operating at a timescale substantially greater than that of a consolidation channel 300, reflecting energetic asymmetry in which consolidation proceeds through gradual barrier energy accumulation while reflux requires perturbation energy proportional to accumulated barrier energy to initiate. A boundary accumulation channel 310 concentrates curvature from an active sector 210 into a boundary sector 215 without completing transit into an irreversible sector 220, operating at a timescale comparable to that of a consolidation channel 300 and representing a state in which curvature accumulation alters boundary structure without satisfying exchange equilibrium. A restructuring channel 315 rebalances curvature within an active sector 210 between semantic curvature associated with a Riemannian semantic metric and epistemic curvature associated with an epistemic connection, operating at a faster timescale than a consolidation channel 300 or boundary accumulation channel 310, and constrained by compatibility conditions of an almost-complex structure and a symplectic form maintained by a cognitive manifold substrate 105.

In an embodiment, exchange channels 300, 305, 310, and 315 operate subject to a curvature conservation law governing redistribution of curvature among sectors and may be implemented through an exchange channel subsystem 120 in coordination with a GPU exchange execution subsystem 140 operating on geometric state maintained by a cognitive manifold substrate 105.

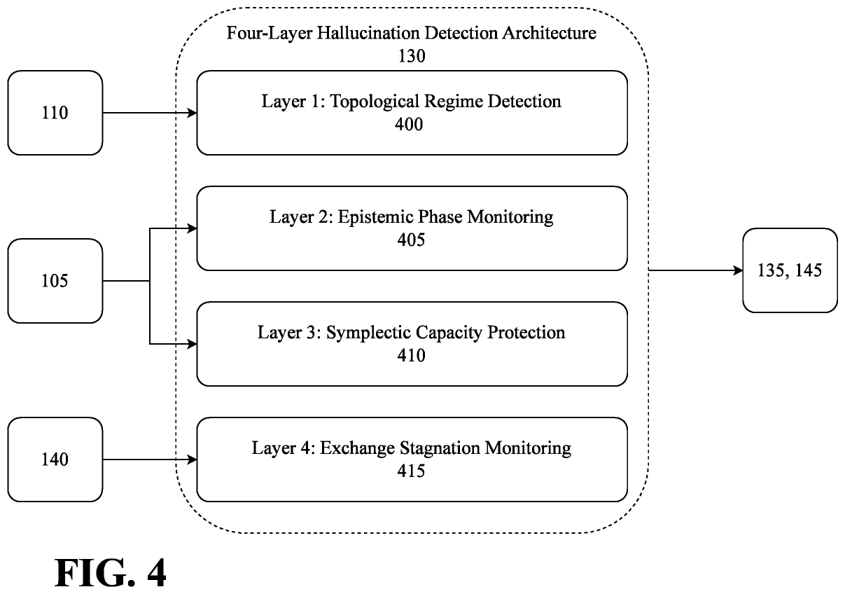

FIG. 4 is a block diagram illustrating exemplary architecture of a four-layer hallucination detection architecture 130, in an embodiment. A four-layer hallucination detection architecture 130 comprises a topological regime detection layer 400, an epistemic phase monitoring layer 405, a symplectic capacity protection layer 410, and an exchange stagnation monitoring layer 415, each of which operates concurrently to identify a distinct class of curvature misrouting event corresponding to a violation of exchange dynamics within system 100. Inputs to a four-layer hallucination detection architecture 130 are received from a sector classification and management subsystem 110, a cognitive manifold substrate 105, and a GPU exchange execution subsystem 140, with each input routed to one or more detection layers based on the geometric state required for evaluation. Misrouting flags produced across all four layers are forwarded to an output generation and expression control subsystem 145, and saturation indicators produced by an exchange stagnation monitoring layer 415 are additionally forwarded to an epistemic horizon detection subsystem 135.

A topological regime detection layer 400 receives barrier-edge bitmap state from a sector classification and management subsystem 110 and evaluates curvature transport across sector boundaries to identify channel bypass events, in which curvature crosses a sector boundary absent corresponding exchange accounting consistent with a curvature conservation law governing inter-sector curvature flow. An epistemic phase monitoring layer 405 receives geometric state from a cognitive manifold substrate 105 and evaluates epistemic holonomy accumulated along active reasoning trajectories, detecting curvature laundering conditions in which epistemic curvature may become concealed within semantic curvature. A symplectic capacity protection layer 410 also reads from a cognitive manifold substrate 105 and evaluates symplectic capacity density at reservoir boundaries, detecting premature export conditions in which curvature may be transferred into an irreversible sector before exchange equilibrium has been reached.

An exchange stagnation monitoring layer 415 receives per-sector curvature flow rate statistics from a GPU exchange execution subsystem 140 and evaluates exchange channel activity to identify exchange-stagnated regions where all exchange channels from a region may be simultaneously saturated, as indicated by curvature remaining within a bounded variation range despite continued evidence flux, maximal coupling strain, and boundary capacity exhaustion. Saturation indicators from an exchange stagnation monitoring layer 415 are provided to an epistemic horizon detection subsystem 135 to support connected-component analysis over an active sector graph, and are additionally forwarded to an output generation and expression control subsystem 145 alongside misrouting flags from the remaining layers. Together, the four detection layers may identify hallucination conditions that are not detectable by any individual layer in isolation, as each layer is sensitive to a distinct geometric failure mode associated with exchange dynamics.

In an embodiment, data flows through a four-layer hallucination detection architecture 130 in parallel with forward-path reasoning traversal occurring within a cognitive manifold substrate 105. As a reasoning trajectory is traversed within an active sector, a topological regime detection layer 400 reads a barrier-edge bitmap maintained by a sector classification and management subsystem 110 and evaluates curvature transport across sector boundaries on a per-edge basis. Concurrently, an epistemic phase monitoring layer 405 accumulates epistemic holonomy along a traversed trajectory by summing per-edge phase values read from a cognitive manifold substrate 105, and a symplectic capacity protection layer 410 evaluates symplectic capacity density at reservoir boundaries using per-face geometric state maintained by a cognitive manifold substrate 105. An exchange stagnation monitoring layer 415 reads per-sector curvature flow rate statistics produced by an exchange accounting kernel of a GPU exchange execution subsystem 140 and evaluates simultaneous saturation conditions across exchange channels. Any misrouting flag generated by any of the four layers during traversal is forwarded to an output generation and expression control subsystem 145, where it may condition an output eligibility determination for the trajectory currently being evaluated, and saturation indicators from an exchange stagnation monitoring layer 415 are concurrently provided to an epistemic horizon detection subsystem 135 for spatial classification of stagnated regions.

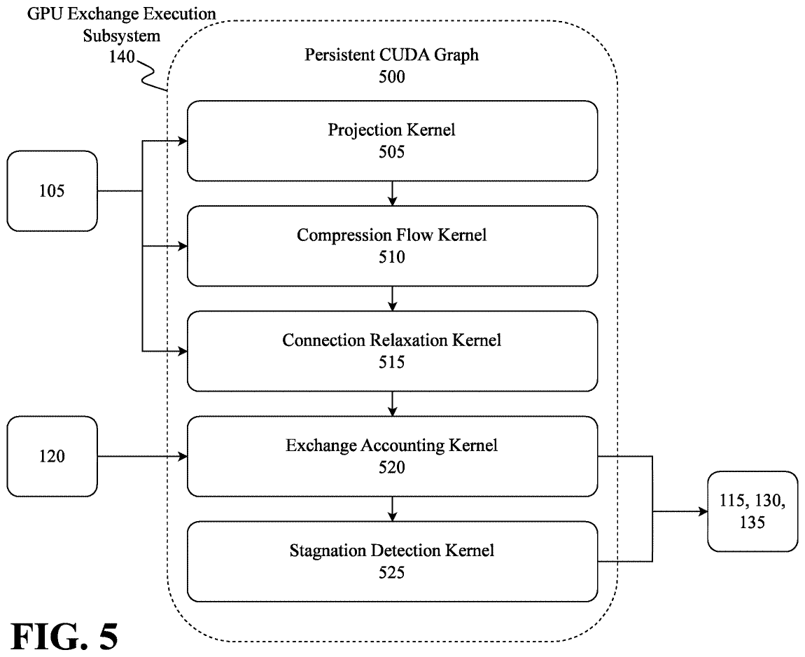

FIG. 5 is a block diagram illustrating exemplary architecture of a GPU exchange execution subsystem 140, in an embodiment. A GPU exchange execution subsystem 140 comprises a persistent CUDA graph 500 within which five computational kernels operate on shared manifold data structures maintained in memory: a projection kernel 505, a compression flow kernel 510, a connection relaxation kernel 515, an exchange accounting kernel K4 520, and a stagnation detection kernel K5 525. Inputs to a GPU exchange execution subsystem 140 are received from a cognitive manifold substrate 105, which supplies the shared simplicial complex data structures on which the geometric kernels operate, and from an exchange channel subsystem 120, which supplies exchange dynamics parameters read by an exchange accounting kernel K4 520. Outputs from a GPU exchange execution subsystem 140 are provided to a curvature conservation enforcement subsystem 115, a four-layer hallucination detection architecture 130, and an epistemic horizon detection subsystem 135.

A projection kernel 505 is configured to implement projection mechanisms described in incorporated parent applications within a GPU execution pipeline, updating vertex, edge, face, and phase data structures on a fast timescale τ_P upon admission of new cognitive states into a cognitive manifold substrate 105, introducing localized updates to manifold geometry that initiate subsequent geometric evolution on slower timescales. A compression flow kernel 510 is configured to minimize a geometric energy functional enforcing almost-Kähler compatibility among geometric structures of a cognitive manifold substrate 105, adjusting semantic metric coordinates and reducing Nijenhuis tensor magnitude by driving regions undergoing stabilization toward approximately compatible geometric configurations, operating on an intermediate timescale τ_C. A connection relaxation kernel 515 is configured to reduce total squared epistemic curvature energy across a cognitive manifold substrate 105 by updating stored edge phase values through gradient descent based on curvature gradients computed over incident faces, operating on a slow timescale τ_R such that timescale ordering τ_P, τ_C, τ_R reflects projection updates preceding geometric adjustment and geometric adjustment preceding epistemic consolidation.

An exchange accounting kernel K4 520 is configured to read per-vertex sector membership and inter-sector curvature flow from manifold data structures produced and maintained by a projection kernel 505, a compression flow kernel 510, and a connection relaxation kernel 515, and to verify a discrete conservation law governing redistribution of curvature among sectors per cycle by confirming that aggregated curvature change across all three sectors equals curvature injected by a projection operator within a numerical tolerance. An exchange accounting kernel K4 520 provides exchange balance statistics to a curvature conservation enforcement subsystem 115 and provides per-channel curvature flow rates to a four-layer hallucination detection architecture 130. A stagnation detection kernel K5 525 reads exchange rate statistics produced by an exchange accounting kernel K4 520 and is configured to evaluate simultaneous saturation conditions across exchange channels, flagging exchange-stagnated regions where curvature may remain within a bounded variation range despite continued evidence flux, coupling strain may be maximal, and boundary capacity may be exhausted. Saturation indicators produced by a stagnation detection kernel K5 525 are provided to a four-layer hallucination detection architecture 130 and to an epistemic horizon detection subsystem 135.

In an embodiment, data flows through a GPU exchange execution subsystem 140 along a shared manifold memory representation updated by kernel operations scheduled within a persistent CUDA graph 500. On a fast timescale, a projection kernel 505 receives admitted cognitive states from a cognitive manifold substrate 105 and updates local vertex, edge, face, and epistemic phase data structures, writing perturbed geometric state back to shared memory. On an intermediate timescale, a compression flow kernel 510 reads updated metric and almost-complex structure data from shared memory and applies batched local updates that reduce Nijenhuis tensor magnitude and enforce almost-Kähler compatibility, writing adjusted coordinates back to shared manifold storage. On a slow timescale, a connection relaxation kernel 515 reads stored edge phase values and computes curvature gradients over incident faces through parallel reductions, applying gradient descent updates that reduce total squared curvature energy and writing updated phase values to shared memory. An exchange accounting kernel K4 520 then reads per-vertex sector membership labels and curvature field data from the manifold state maintained by the three geometric kernels, computes inter-sector curvature flow, verifies the discrete conservation law, and writes per-cycle exchange balance statistics and per-channel flow rates to output buffers read by a curvature conservation enforcement subsystem 115 and a four-layer hallucination detection architecture 130. A stagnation detection kernel K5 525 reads exchange rate statistics from K4 output buffers, evaluates saturation conditions across all exchange channels for each manifold region, and writes stagnation indicators to output buffers provided to a four-layer hallucination detection architecture 130 and an epistemic horizon detection subsystem 135.

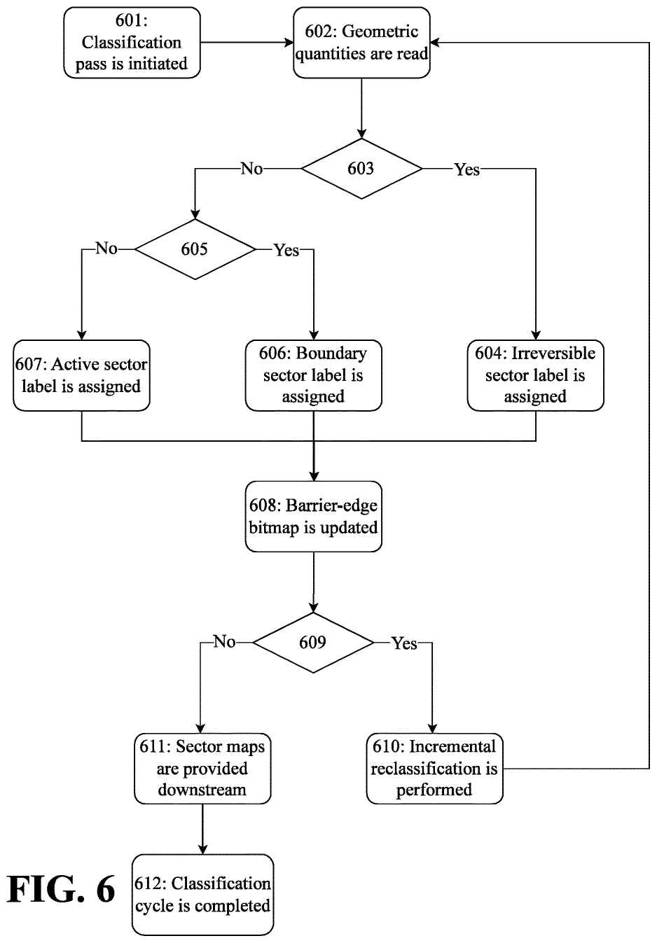

FIG. 6 is a flow diagram illustrating exemplary sector classification, in an embodiment. Sector classification is performed by a sector classification and management subsystem 110 operating on geometric state maintained by a cognitive manifold substrate 105 and proceeds at each cognitive cycle to assign per-vertex sector membership labels across a simplicial complex representing a cognitive manifold. In an embodiment, sector classification reflects emergent geometric regimes identified through evaluation of local curvature, barrier energy, and boundary proximity under conservation-governed exchange dynamics, rather than application of externally imposed categorical rules.

Per-cycle sector classification begins when a sector classification and management subsystem 110 initiates a classification pass over vertices of a simplicial complex maintained by a cognitive manifold substrate 105 601. In an embodiment, the classification pass may be executed in parallel across vertices using GPU threads operating on per-vertex data stored in shared memory. The subsystem reads per-vertex geometric quantities from a cognitive manifold substrate 105, comprising epistemic curvature magnitude, local barrier energy, Nijenhuis tensor magnitude, and proximity to known reservoir boundaries 602. In an embodiment, local barrier energy is computed from accumulated curvature at adjacent boundary regions and energy costs associated with transitions across neighboring vertices of differing sector membership, and proximity to reservoir boundaries is determined based on graph distance or geodesic distance within the simplicial complex.

The subsystem evaluates whether epistemic curvature magnitude at a vertex is at or below a flatness threshold and whether local barrier energy is at or above a barrier threshold 603, wherein in an embodiment such thresholds are derived from exchange equilibrium conditions under a curvature conservation law rather than fixed design parameters. When both conditions are satisfied, the subsystem assigns a sector membership label to the vertex indicating membership in an irreversible sector and writes the label to per-vertex storage 604. When either condition is not satisfied, the subsystem evaluates whether the vertex falls within a tubular neighborhood of a reservoir boundary 605, wherein in an embodiment the tubular neighborhood is defined as a set of vertices within a bounded graph or geodesic distance from a boundary satisfying a barrier energy gradient criterion. When the vertex falls within such a neighborhood, the subsystem assigns a sector membership label indicating membership in a boundary sector and stores the label in per-vertex storage 606. When the vertex does not fall within a tubular neighborhood of a reservoir boundary, the subsystem assigns a sector membership label indicating membership in an active sector and stores the label in per-vertex storage 607.

Following assignment of sector membership labels for vertices, the subsystem updates a barrier-edge bitmap to reflect edges crossing sector boundaries based on updated per-vertex labels 608, wherein the bitmap identifies edges connecting vertices of differing sector membership for use in exchange monitoring and hallucination detection. The subsystem then evaluates whether local geometric properties have changed at any vertex since a prior classification pass 609, wherein in an embodiment change is determined based on variation in one or more of epistemic curvature magnitude, barrier energy, Nijenhuis tensor magnitude, or boundary proximity exceeding a numerical tolerance. When local geometric properties have changed at one or more vertices, the subsystem identifies affected vertices for incremental reclassification and returns to read updated geometric quantities from a cognitive manifold substrate 105 610, wherein incremental reclassification may be limited to affected regions to reduce computational overhead. When no changes in local geometric properties are detected, the subsystem provides updated sector maps and the barrier-edge bitmap to downstream subsystems comprising an exchange channel subsystem 120, a curvature conservation enforcement subsystem 115, and a four-layer hallucination detection architecture 130 611. Sector classification for the current cognitive cycle is then complete 612.

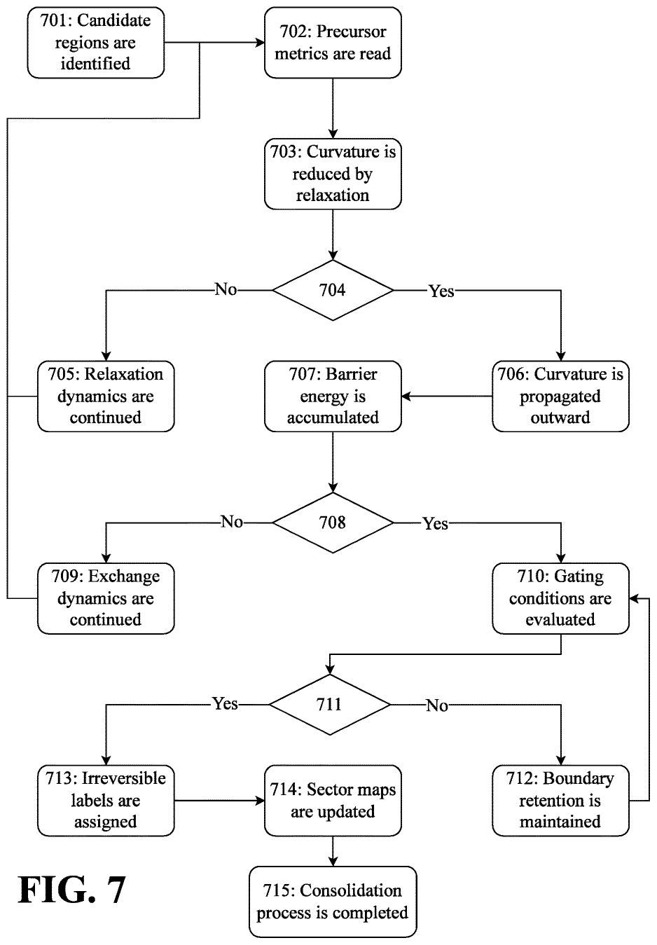

FIG. 7 is a flow diagram illustrating exemplary consolidation process, in an embodiment. The consolidation process is performed by a consolidation and reflux subsystem 125 in coordination with an exchange channel subsystem 120 and a GPU exchange execution subsystem 140, operating on geometric state maintained by a cognitive manifold substrate 105, and proceeds through emergent stages of curvature redistribution under a conservation law culminating in reservoir formation within an irreversible sector. In an embodiment, consolidation reflects attainment of exchange equilibrium under conservation-constrained dynamics, with gating conditions validating admissibility of the resulting configuration rather than initiating consolidation.

Consolidation monitoring begins when a consolidation and reflux subsystem 125 initiates monitoring of candidate regions within an active sector approaching reservoir readiness 701, wherein in an embodiment a candidate region comprises a connected set of vertices identified based on curvature coherence and adjacency to a boundary sector. The subsystem reads consolidation precursor metrics from a cognitive manifold substrate 105, comprising epistemic curvature magnitude, local barrier energy, and Nijenhuis tensor magnitude 702. A connection relaxation kernel 515 of a GPU exchange execution subsystem 140 drives epistemic curvature magnitude within a candidate region toward a reduced-energy configuration through relaxation dynamics applied across edges of the simplicial complex 703. A determination is made whether epistemic curvature in the candidate region has decreased below a flatness threshold derived from exchange equilibrium conditions under a curvature conservation law 704. When epistemic curvature has not decreased below the flatness threshold, relaxation dynamics continue and updated precursor metrics are read from a cognitive manifold substrate 105 705.

When epistemic curvature has decreased below the flatness threshold, curvature is propagated along edges adjacent to a boundary sector through exchange dynamics governed by an exchange channel subsystem 120, resulting in outward redistribution of curvature from the candidate region 706. Redistributed curvature is accumulated at boundary vertices as barrier energy through updates to boundary-associated energy values stored in the simplicial complex, increasing resistance to perturbation of the candidate region 707. A determination is made whether exchange equilibrium has been reached such that interior epistemic curvature is below the flatness threshold and boundary barrier energy satisfies a threshold determined by a curvature budget under the conservation law 708. When exchange equilibrium has not been reached, exchange dynamics continue and updated precursor metrics are read from a cognitive manifold substrate 105 709.

When exchange equilibrium has been reached, gating conditions for the candidate region are evaluated, comprising epistemic admissibility, epistemic coherence, and symplectic capacity admissibility as determined by a four-layer hallucination detection architecture 130 and an exchange channel subsystem 120 710. A determination is made whether all gating conditions are concurrently satisfied 711. When one or more gating conditions are not satisfied, curvature is retained within a boundary sector pending satisfaction of the gating conditions and the evaluation is repeated 712. When all gating conditions are concurrently satisfied, a sector membership label corresponding to an irreversible sector is assigned to vertices of the candidate region and stored in per-vertex storage to form a consolidated knowledge reservoir 713. A sector classification and management subsystem 110 is notified to update sector membership labels and a barrier-edge bitmap to reflect the newly formed reservoir 714. Consolidation of the candidate region is then complete 715.

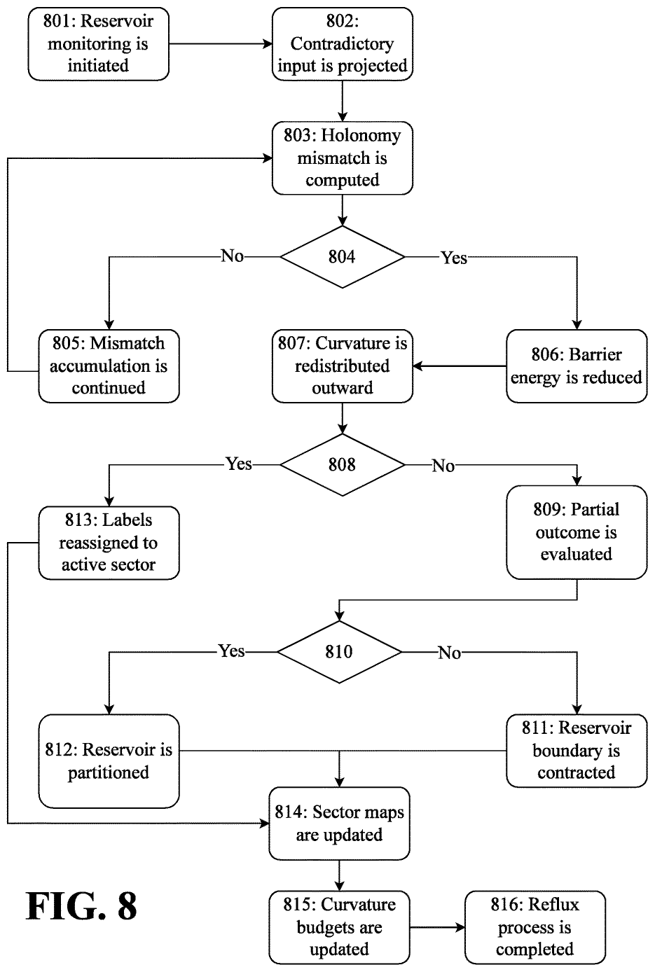

FIG. 8 is a flow diagram illustrating exemplary reflux process, in an embodiment. The reflux process is performed by a consolidation and reflux subsystem 125 in coordination with a curvature conservation enforcement subsystem 115 and an exchange channel subsystem 120, operating on geometric state maintained by a cognitive manifold substrate 105, and proceeds through holonomy mismatch accumulation, barrier energy reduction, and curvature redistribution into an active sector under conservation-constrained dynamics. In an embodiment, reflux reflects thermodynamically asymmetric revision in which release of previously consolidated curvature occurs only upon accumulation of mismatch sufficient to overcome barrier energy at a reservoir boundary.

Reflux monitoring begins when a consolidation and reflux subsystem 125 initiates monitoring of consolidated knowledge reservoirs within an irreversible sector 801. A projection operator projects contradictory evidence into an active sector, introducing curvature incompatible with consolidated content of a monitored reservoir and updating per-vertex and per-edge geometric state within a simplicial complex 802. Holonomy mismatch is computed at boundary edges as accumulated epistemic phase deviation between projected curvature and existing reservoir boundary structure, and is aggregated across boundary-adjacent vertices to produce a mismatch measure at the reservoir boundary 803. A determination is made whether accumulated holonomy mismatch exceeds a threshold determined as a function of barrier energy at the reservoir boundary under the curvature conservation law 804. When accumulated mismatch has not exceeded the threshold, monitoring continues and mismatch accumulation at the reservoir boundary is updated based on subsequent projections and local geometric evolution 805.

When accumulated mismatch exceeds the threshold, boundary-associated barrier energy values stored at boundary vertices are reduced in response to the accumulated mismatch, weakening resistance to inter-sector curvature transfer 806. Curvature values associated with the reservoir interior are redistributed across boundary edges into an active sector through exchange dynamics governed by an exchange channel subsystem 120, producing unconstrained curvature available for restructuring 807. A determination is made whether accumulated mismatch is sufficient to fully de-consolidate the reservoir based on comparison of mismatch magnitude to total barrier energy associated with the reservoir boundary 808. When accumulated mismatch is not sufficient for full de-consolidation, a determination is made whether redistribution of curvature results in a connected reduction of the reservoir boundary or a topological separation into multiple connected components 809. A determination is made whether partial de-consolidation produces multiple disconnected components within the reservoir region 810. When partial de-consolidation does not produce multiple disconnected components, the reservoir boundary contracts and per-vertex sector membership labels are updated to reduce the extent of the irreversible sector at the affected boundary region 811. When partial de-consolidation produces multiple disconnected components, the reservoir is partitioned into multiple sub-reservoirs, each assigned updated sector membership labels within the irreversible sector 812. When accumulated mismatch is sufficient for full de-consolidation, sector membership labels for vertices of the reservoir are reassigned from the irreversible sector to the active sector, reflecting transition of the region into an unconstrained state 813.

Following any de-consolidation outcome, a sector classification and management subsystem 110 is notified to update sector membership labels and a barrier-edge bitmap to reflect the revised reservoir boundary structure 814. A curvature conservation enforcement subsystem 115 updates per-sector curvature budgets to reflect curvature redistributed into the active sector during the reflux event, maintaining consistency with the conservation law 815. Reflux is then complete 816.

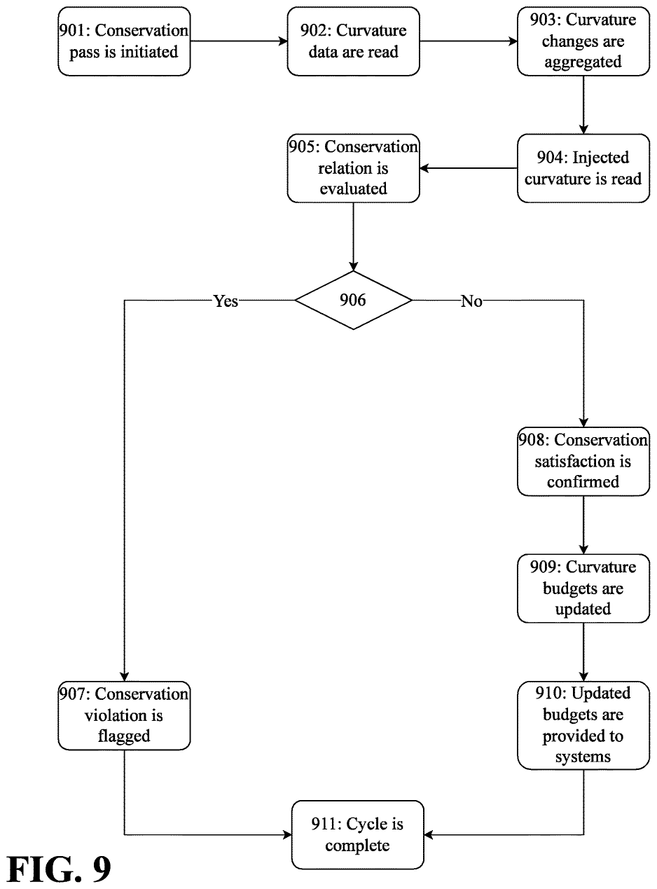

FIG. 9 is a flow diagram illustrating exemplary conservation enforcement cycle, in an embodiment. The conservation enforcement cycle is performed by a curvature conservation enforcement subsystem 115 in coordination with an exchange accounting kernel K4 520 of a GPU exchange execution subsystem 140, operating on geometric state maintained by a cognitive manifold substrate 105, and proceeds at each cognitive cycle to verify that redistribution of curvature energy among sectors satisfies a discrete conservation relationship under a curvature conservation law.

The conservation enforcement cycle begins when a curvature conservation enforcement subsystem 115 initiates a conservation verification pass for the current cognitive cycle 901. An exchange accounting kernel K4 520 reads per-vertex sector membership labels and curvature field data from a cognitive manifold substrate 105 for the current cycle 902. In an embodiment, curvature field data comprises semantic curvature, epistemic curvature, and coupling strain values stored across vertices, edges, and faces of a simplicial complex. An exchange accounting kernel K4 520 computes per-cycle curvature change for each sector by aggregating differences between current and prior-cycle curvature values across vertices associated with an active sector, a boundary sector, and an irreversible sector 903. An exchange accounting kernel K4 520 reads curvature injected by a projection operator as a conservation forcing term for the current cycle, wherein in an embodiment the injected curvature is computed as an aggregate of curvature contributions assigned to vertices during projection of new input 904. A comparison is performed between aggregated total curvature change across all three sectors and curvature injected by the projection operator in accordance with a discrete conservation relationship ΔE_total=ΔE_M_active+ΔE_B+ΔE_P=Φ_ext 905. A determination is made whether a discrepancy between aggregated curvature change and injected curvature exceeds a numerical tolerance, wherein in an embodiment the tolerance corresponds to allowable numerical error in parallel aggregation operations 906. When the discrepancy exceeds the numerical tolerance, a conservation violation is flagged and a diagnostic record identifying affected regions and discrepancy magnitude is routed to a GPU exchange execution subsystem 140 for analysis 907.

When the discrepancy does not exceed the numerical tolerance, satisfaction of the discrete conservation law for the current cycle is confirmed 908. A curvature conservation enforcement subsystem 115 updates per-sector curvature budgets and exchange balance statistics to reflect redistribution of curvature occurring during the current cycle, wherein in an embodiment exchange balance statistics track curvature inflow and outflow across sector boundaries 909. Updated per-sector curvature budgets and exchange balance statistics are provided to an exchange channel subsystem 120 and a four-layer hallucination detection architecture 130 to support subsequent exchange dynamics and misrouting detection 910. The conservation enforcement cycle is then complete for the current cycle 911.

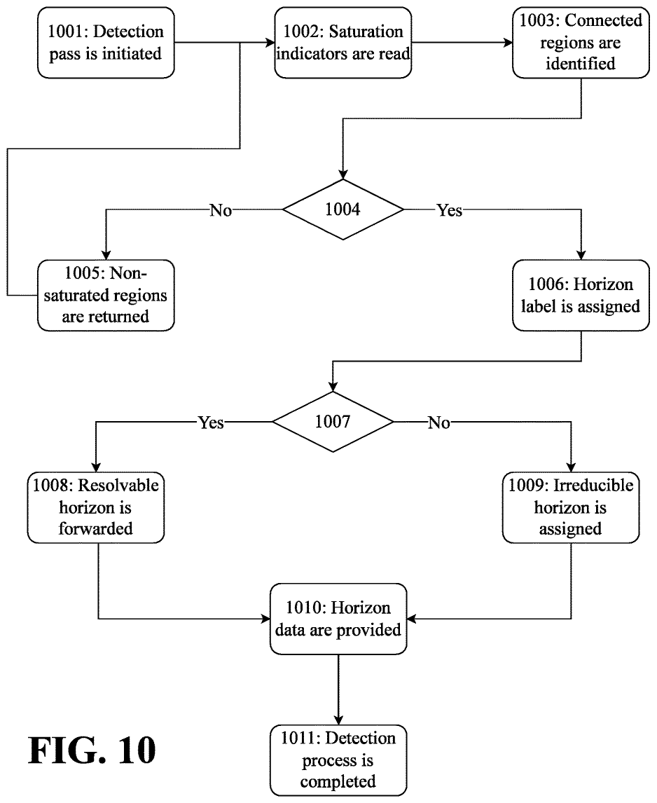

FIG. 10 is a flow diagram illustrating exemplary epistemic horizon detection, in an embodiment. Epistemic horizon detection is performed by an epistemic horizon detection subsystem 135 in coordination with a stagnation detection kernel K5 525 of a GPU exchange execution subsystem 140 and a four-layer hallucination detection architecture 130, operating on exchange saturation indicators derived from geometric state maintained by a cognitive manifold substrate 105, and proceeds through connected-region identification, simultaneous exchange channel saturation evaluation, and classification of regions as resolvable or irreducible based on availability of admissible exchange pathways.

Epistemic horizon detection begins when an epistemic horizon detection subsystem 135 initiates a detection pass over regions of an active sector 1001. The subsystem reads per-region exchange saturation indicators from a stagnation detection kernel K5 525 and layer 4 of a four-layer hallucination detection architecture 130, wherein in an embodiment the indicators comprise curvature change rates, coupling strain values derived from a Nijenhuis tensor, boundary capacity utilization levels, and per-region exchange flow rates 1002. The subsystem performs connected-component analysis over a graph representation of the active sector to identify candidate regions comprising connected sets of vertices exhibiting elevated saturation indicators 1003. A determination is made whether a candidate region simultaneously satisfies exchange saturation conditions, comprising: (i) trapped curvature exceeding a saturation threshold derived from local curvature energy distribution, (ii) coupling strain exceeding a threshold corresponding to near-maximal Nijenhuis tensor magnitude within the region, (iii) stalled dynamics indicated by curvature change below a temporal variation threshold across a plurality of consecutive cognitive cycles, and (iv) boundary capacity exhaustion indicated by absence of available boundary capacity for curvature accumulation at adjacent boundary vertices 1004. When a candidate region does not simultaneously satisfy all exchange saturation conditions, the region is returned to exchange monitoring and updated saturation indicators are read for subsequent evaluation 1005.

When a candidate region simultaneously satisfies all exchange saturation conditions, a region label is assigned indicating classification as an epistemic horizon 1006. A determination is made whether the epistemic horizon is resolvable based on availability of admissible exchange pathways, wherein in an embodiment resolvability is determined by evaluating whether adjacent boundary regions exhibit non-saturated capacity, whether curvature gradients exist that permit redistribution under exchange dynamics, or whether newly projected curvature introduces admissible pathways for exchange 1007. When the horizon is determined to be resolvable, a label indicating resolvable horizon status is assigned and horizon location and severity metrics are forwarded to an exchange channel subsystem 120 for intervention 1008. When the horizon is determined to be irreducible, a label indicating irreducible horizon status is assigned, representing absence of admissible exchange pathways under current manifold geometry 1009. Following either classification, horizon classification and severity metrics are provided to an output generation and expression control subsystem 145 to condition output generation 1010. Epistemic horizon detection is then complete 1011.

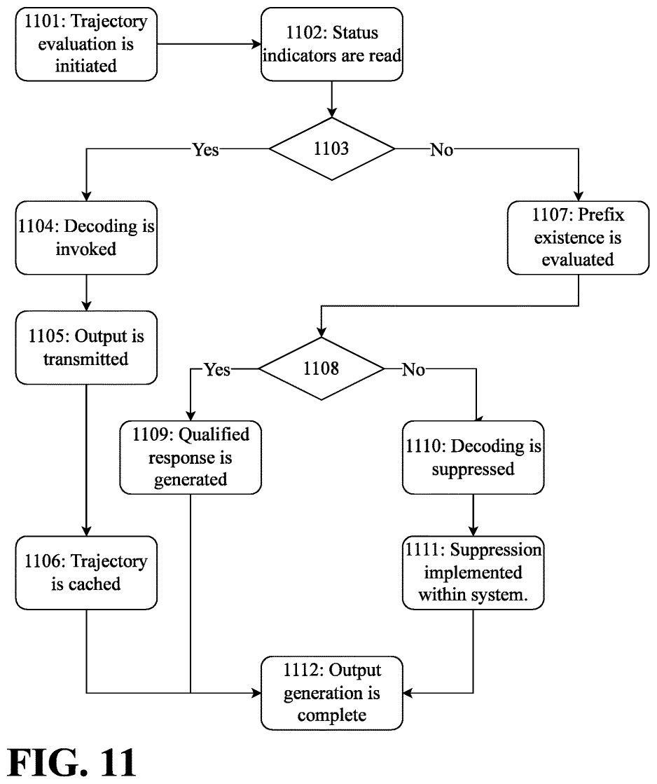

FIG. 11 is a flow diagram illustrating exemplary output generation and expression control, in an embodiment. Output generation and expression control is performed by an output generation and expression control subsystem 145 operating on epistemic admissibility status, misrouting flags, and horizon classifications received from a four-layer hallucination detection architecture 130 and an epistemic horizon detection subsystem 135, and proceeds through an output eligibility determination to one of three outcome branches: full output generation, qualified response, or suppression. In an embodiment, output determination is conditioned on geometric validity of reasoning trajectories as reflected in curvature-consistent admissibility, absence of curvature misrouting, and availability of admissible exchange pathways.

Output eligibility determination begins when an output generation and expression control subsystem 145 initiates evaluation of a completed reasoning trajectory 1101. The subsystem reads epistemic admissibility status, misrouting flags from a four-layer hallucination detection architecture 130, and horizon classifications from an epistemic horizon detection subsystem 135 1102. A determination is made whether epistemic admissibility status is affirmative, no misrouting flags are active, and no irreducible epistemic horizon classification is associated with the completed trajectory 1103. When epistemic admissibility status is affirmative, no misrouting flags are active, and no irreducible epistemic horizon is present, manifold-conditioned decoding is invoked to map admissible cognitive states into an external representation comprising, in an embodiment, a natural language response, symbolic structure, or executable action 1104. The decoded representation is transmitted to an external interface 1105. The completed trajectory is routed to an evolutionary thought caching architecture of an incorporated parent application as a candidate for caching, with curvature sector provenance recorded as context DNA markers 1106.

When epistemic admissibility status is not affirmative, one or more misrouting flags are active, or an irreducible epistemic horizon is present, a determination is made whether an admissible prefix of the reasoning trajectory exists, wherein in an embodiment the admissible prefix comprises a subsequence of the trajectory up to a first detected misrouting event or horizon condition 1107. A determination is made whether such an admissible prefix exists 1108. When an admissible prefix exists, a qualified response is generated from the admissible prefix, accompanied by structured indications of epistemic insufficiency comprising misrouting type, horizon classification, and location of exchange violation within a sector map 1109. When no admissible prefix exists, decoding is suppressed and a suppression response is generated without emitting content derived from an inadmissible trajectory 1110. Suppression is implemented as a defined architectural state within system 100 rather than an error condition 1111. Output generation and expression control is then complete 1112.

### Exemplary Computing Environment

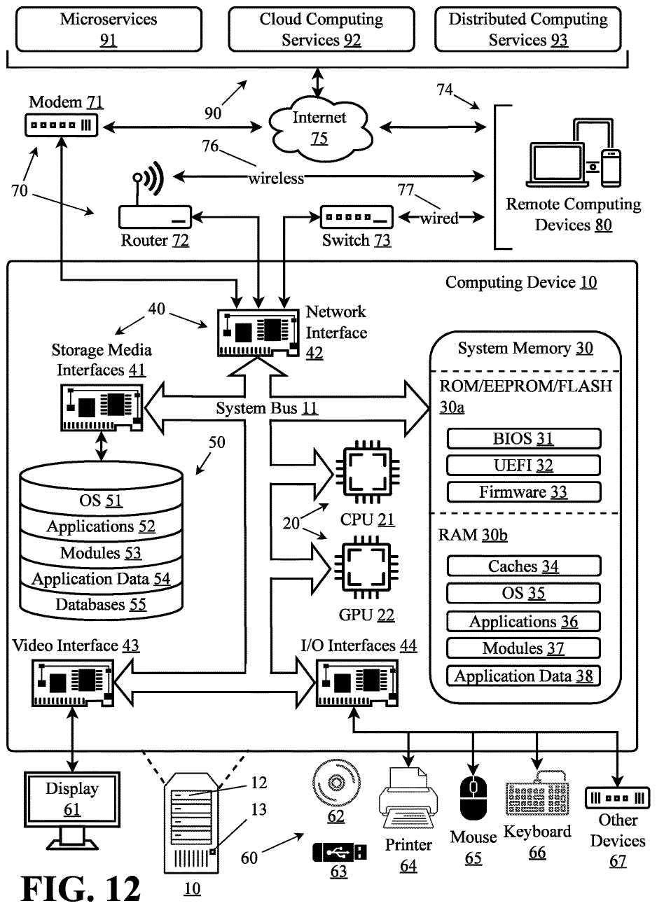

FIG. 12 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising at least one processor, a memory, and a plurality of programming instructions stored on a non-transitory memory and configured to cause the at least one processor to:
maintain a three-sector cognitive architecture comprising an active sector in which reasoning occurs as dynamic traversal of a cognitive manifold, an irreversible sector comprising consolidated knowledge reservoirs with connection structure having epistemic curvature below a flatness threshold and barrier energy exceeding a barrier threshold, and a boundary sector that mediates all exchange between the active sector and the irreversible sector, wherein each sector occupies a distinct region of the cognitive manifold and is characterized by distinct geometric properties;
enforce a curvature conservation law governing total curvature energy distributed across the active sector, the boundary sector, and the irreversible sector by verifying per cycle that a total curvature change across all three sectors equals curvature injected by a projection operator within a numerical tolerance, wherein in the absence of new external experience curvature is redistributed among the three sectors but is neither created nor destroyed;
implement a plurality of exchange channels governing curvature flow among the three sectors, the exchange channels comprising a consolidation channel that transports curvature from the active sector through the boundary sector into the irreversible sector, a restructuring channel that redistributes curvature within the active sector, a boundary accumulation channel that concentrates curvature from the active sector into the boundary sector, and a reflux channel that transports curvature from the irreversible sector through the boundary sector back into the active sector, wherein the energetic cost of activating the reflux channel exceeds the energetic cost of activating the consolidation channel by a factor determined by accumulated barrier energy at the reservoir boundary; and
detect hallucination conditions as curvature misrouting events comprising at least one of channel bypass in which curvature penetrates a topological barrier without traversing a legitimate exchange channel, curvature laundering in which epistemic curvature is concealed within semantic curvature, premature export in which curvature is sealed into the irreversible sector before reaching exchange equilibrium, and blocked export in which curvature is trapped in the active sector due to exchange channel stagnation.

2. The computer system of claim 1, wherein the cognitive manifold is an epistemically conditioned manifold equipped with four mutually compatible geometric structures comprising a Riemannian semantic metric, an almost-complex structure, a compatible symplectic form satisfying an almost-Kähler compatibility condition, and an epistemic line bundle with connection whose curvature measures evidential coherence.

3. The computer system of claim 1, wherein each consolidated knowledge reservoir in the irreversible sector satisfies three conditions comprising phase flatness such that the supremum of epistemic curvature within the reservoir is bounded by a flatness threshold determined by evidence consistency and a spectral gap of a connection Laplacian, barrier energy at the reservoir boundary at least equal to a barrier threshold determined by a curvature budget of the curvature conservation law, and admission control at the reservoir boundary routing compatible cognitive states into the reservoir while excluding incompatible states.

4. The computer system of claim 1, wherein the consolidation channel operates in four stages comprising epistemic relaxation in the active sector, curvature migration through boundary edges, barrier accumulation at reservoir boundaries, and exchange equilibrium, and wherein the four stages emerge from continuous relaxation dynamics under the curvature conservation law.

5. The computer system of claim 1, wherein the reflux channel is driven by holonomy mismatch such that contradictory evidence accumulates curvature at the boundary sector that is incompatible with the corresponding reservoir's consolidated content, and wherein the reflux channel activates when the accumulated mismatch exceeds a threshold determined by the barrier energy of the reservoir.

6. The computer system of claim 1, wherein the exchange channels are ordered by timescale such that the restructuring channel operates at a fast timescale, the consolidation channel and boundary accumulation channel operate at an intermediate timescale, and the reflux channel operates at a slow timescale, the timescale ordering reflecting thermodynamic asymmetry such that the energetic cost of activating the reflux channel exceeds the energetic cost of activating the consolidation channel by a factor determined by the accumulated barrier energy at the reservoir boundary.

7. The computer system of claim 1, wherein detecting channel bypass comprises maintaining a barrier-edge bitmap tracking edges of a simplicial complex that cross sector boundaries and monitoring whether curvature transport crosses barrier edges without corresponding exchange accounting consistent with the curvature conservation law.

8. The computer system of claim 1, wherein detecting curvature laundering comprises continuously monitoring epistemic holonomy accumulated along active reasoning trajectories and flagging the trajectory when epistemic phase drift exceeds a threshold, the monitoring occurring at a rate of at least one evaluation per characteristic laundering timescale to ensure detection before laundering is complete.

9. The computer system of claim 1, wherein detecting premature export comprises monitoring a symplectic capacity density at reservoir boundaries and preventing curvature export when post-insertion capacity density exceeds a threshold derived from a symplectic non-squeezing constraint on consolidated knowledge volume.

10. The computer system of claim 1, wherein detecting blocked export comprises monitoring per-sector curvature flow rates and per-reservoir exchange balance and identifying exchange-stagnated regions where all exchange channels from the region are simultaneously saturated as indicated by unchanging curvature despite evidence flux, maximal coupling strain, and boundary capacity exhaustion.

11. The computer system of claim 1, further configured to detect epistemic horizons as connected regions of the active sector where all exchange channels are simultaneously saturated, curvature is trapped, coupling strain is maximal, and dynamics have stalled.

12. The computer system of claim 1, wherein the cognitive manifold is realized as a simplicial complex stored on GPU hardware with a persistent CUDA graph, and wherein the exchange dynamics are implemented through at least an exchange accounting kernel that tracks per-vertex sector membership and inter-sector curvature flow and verifies the discrete conservation law per cycle, and a stagnation detection kernel that monitors exchange rates and flags exchange-stagnated regions.

13. The computer system of claim 1, wherein total complexity across all three sectors scales logarithmically with accumulated experience such that N_total=N_active+N_P+N_B=O(log E), and wherein revision events do not increase total complexity because de-consolidated vertices are reclassified rather than created.

14. A method for conservation-governed cognitive processing, comprising:
maintaining, by at least one processor, a three-sector cognitive architecture comprising an active sector in which reasoning occurs as dynamic traversal of a cognitive manifold, an irreversible sector comprising consolidated knowledge reservoirs with connection structure having epistemic curvature below a flatness threshold and barrier energy exceeding a barrier threshold, and a boundary sector mediating all exchange between the active sector and the irreversible sector, wherein each sector occupies a distinct region of the cognitive manifold and is characterized by distinct geometric properties;
enforcing a curvature conservation law governing total curvature energy distributed across the three sectors by verifying per cycle that a total curvature change across all three sectors equals curvature injected by a projection operator within a numerical tolerance, wherein in the absence of new external experience curvature is redistributed among the sectors but is neither created nor destroyed;
implementing a plurality of exchange channels governing curvature flow among the three sectors, the exchange channels comprising a consolidation channel that transports curvature from the active sector through the boundary sector into the irreversible sector, a restructuring channel that redistributes curvature within the active sector, a boundary accumulation channel that concentrates curvature from the active sector into the boundary sector, and a reflux channel that transports curvature from the irreversible sector through the boundary sector back into the active sector, wherein the energetic cost of activating the reflux channel exceeds the energetic cost of activating the consolidation channel by a factor determined by accumulated barrier energy at the reservoir boundary; and
detecting hallucination conditions as curvature misrouting events comprising at least one of channel bypass in which curvature penetrates a topological barrier without traversing a legitimate exchange channel, curvature laundering in which epistemic curvature is concealed within semantic curvature, premature export in which curvature is sealed into the irreversible sector before reaching exchange equilibrium, and blocked export in which curvature is trapped in the active sector due to exchange channel stagnation.

15. The method of claim 14, wherein the cognitive manifold is an epistemically conditioned manifold equipped with four mutually compatible geometric structures comprising a Riemannian semantic metric, an almost-complex structure, a compatible symplectic form satisfying an almost-Kähler compatibility condition, and an epistemic line bundle with connection whose curvature measures evidential coherence.

16. The method of claim 14, wherein each consolidated knowledge reservoir in the irreversible sector satisfies three conditions comprising phase flatness such that the supremum of epistemic curvature within the reservoir is bounded by a flatness threshold determined by evidence consistency and a spectral gap of a connection Laplacian, barrier energy at the reservoir boundary at least equal to a barrier threshold determined by a curvature budget of the curvature conservation law, and admission control at the reservoir boundary routing compatible cognitive states into the reservoir while excluding incompatible states.

17. The method of claim 14, wherein the consolidation channel operates in four stages comprising epistemic relaxation in the active sector, curvature migration through boundary edges, barrier accumulation at reservoir boundaries, and exchange equilibrium, and wherein the four stages emerge from continuous relaxation dynamics under the curvature conservation law.

18. The method of claim 14, wherein the reflux channel is driven by holonomy mismatch such that contradictory evidence accumulates curvature at the boundary sector that is incompatible with the corresponding reservoir's consolidated content, and wherein the reflux channel activates when the accumulated mismatch exceeds a threshold determined by the barrier energy of the reservoir.

19. The method of claim 14, wherein the exchange channels are ordered by timescale such that the restructuring channel operates at a fast timescale, the consolidation channel and boundary accumulation channel operate at an intermediate timescale, and the reflux channel operates at a slow timescale, the timescale ordering reflecting thermodynamic asymmetry such that the energetic cost of activating the reflux channel exceeds the energetic cost of activating the consolidation channel by a factor determined by the accumulated barrier energy at the reservoir boundary.

20. The method of claim 14, wherein detecting channel bypass comprises maintaining a barrier-edge bitmap tracking edges of a simplicial complex that cross sector boundaries and monitoring whether curvature transport crosses barrier edges without corresponding exchange accounting consistent with the curvature conservation law.

21. The method of claim 14, wherein detecting curvature laundering comprises continuously monitoring epistemic holonomy accumulated along active reasoning trajectories and flagging the trajectory when epistemic phase drift exceeds a threshold, the monitoring occurring at a rate of at least one evaluation per characteristic laundering timescale to ensure detection before laundering is complete.

22. The method of claim 14, wherein detecting premature export comprises monitoring a symplectic capacity density at reservoir boundaries and preventing curvature export when post-insertion capacity density exceeds a threshold derived from a symplectic non-squeezing constraint on consolidated knowledge volume.

23. The method of claim 14, wherein detecting blocked export comprises monitoring per-sector curvature flow rates and per-reservoir exchange balance and identifying exchange-stagnated regions where all exchange channels from the region are simultaneously saturated as indicated by unchanging curvature despite evidence flux, maximal coupling strain, and boundary capacity exhaustion.

24. The method of claim 14, further comprising detecting epistemic horizons as connected regions of the active sector where all exchange channels are simultaneously saturated, curvature is trapped, coupling strain is maximal, and dynamics have stalled.

25. The method of claim 14, wherein the cognitive manifold is realized as a simplicial complex stored on GPU hardware with a persistent CUDA graph, and wherein the exchange dynamics are implemented through at least an exchange accounting kernel that tracks per-vertex sector membership and inter-sector curvature flow and verifies the discrete conservation law per cycle, and a stagnation detection kernel that monitors exchange rates and flags exchange-stagnated regions.

26. The method of claim 14, wherein total complexity across all three sectors scales logarithmically with accumulated experience such that N_total=N_active+N_P+N_B=O(log E), and wherein revision events do not increase total complexity because de-consolidated vertices are reclassified rather than created.

27. A non-transitory computer-readable medium storing programming instructions that, when executed by at least one processor, cause the at least one processor to perform operations comprising:
maintaining a three-sector cognitive architecture comprising an active sector in which reasoning occurs as dynamic traversal of a cognitive manifold, an irreversible sector comprising consolidated knowledge reservoirs with connection structure having epistemic curvature below a flatness threshold and barrier energy exceeding a barrier threshold, and a boundary sector mediating all exchange between the active sector and the irreversible sector, wherein each sector occupies a distinct region of the cognitive manifold and is characterized by distinct geometric properties;
enforcing a curvature conservation law governing total curvature energy distributed across the three sectors by verifying per cycle that a total curvature change across all three sectors equals curvature injected by a projection operator within a numerical tolerance, wherein in the absence of new external experience curvature is redistributed among the sectors but is neither created nor destroyed;
implementing a plurality of exchange channels governing curvature flow among the three sectors, the exchange channels comprising a consolidation channel that transports curvature from the active sector through the boundary sector into the irreversible sector, a restructuring channel that redistributes curvature within the active sector, a boundary accumulation channel that concentrates curvature from the active sector into the boundary sector, and a reflux channel that transports curvature from the irreversible sector through the boundary sector back into the active sector, wherein the energetic cost of activating the reflux channel exceeds the energetic cost of activating the consolidation channel by a factor determined by accumulated barrier energy at the reservoir boundary; and
detecting hallucination conditions as curvature misrouting events comprising at least one of channel bypass in which curvature penetrates a topological barrier without traversing a legitimate exchange channel, curvature laundering in which epistemic curvature is concealed within semantic curvature, premature export in which curvature is sealed into the irreversible sector before reaching exchange equilibrium, and blocked export in which curvature is trapped in the active sector due to exchange channel stagnation.
